(19) United States
(12) Patent Application Publication
(10) Pub. No.: US 2009/0265732 A1
(43) Pub. Date: Oct. 22, 2009

(54) CONTENTS PROVIDING SYSTEM, AND CONTENTS PROVIDING METHOD

(75) Inventors: Shinichi Ide, Tokyo (JP); Takumi Ikeda, Hyogo (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/063,895

(22) PCT Filed: Feb. 11, 2006
(86) PCT No.: PCT/JP2006/302393

§ 371 Date: Feb. 15, 2008

(30) Foreign Application Priority Data
Aug. 16, 2005 (JP) 2005-236084

(51) Int. Cl. H04N 7/10; G06F 3/048; H04N 7/173; G06Q 30/00

(52) U.S. Cl. 725/32; 715/835; 715/781; 705/14.4

(57) ABSTRACT

A contents processing device for displaying contents is enabled to change the display format of a contents displaying display unit and to display not only the contents but also other information. As problem solving means, there is proposed a contents providing system, which includes a display unit for displaying the contents and an interlocked icon interlocked with the contents in one area. Further included is a contents processing device which has a function to change the display format of the display unit in case a signal received when the interlocked icon is displayed in the display unit satisfies a predetermined condition. The contents processing device performs the change of the display format, if the interlocked icon is displayed when the contents processing device receives the signal satisfying the predetermined condition from a remote control device. In case the display format is to be changed, it is possible to perform the display in an enlarged/reduced scale but also to add a new window and to display advertising information in the new window added.

### BACKGROUND OF THE INVENTION

1. Field of the Invention

The present invention relates to a content delivery system with a function that changes the display format of a content display section for displaying relevant content and an interlocked icon based on signals received while the relevant content and the interlocked icon are being displayed.

2. Description of the Related Art

Conventionally, it is possible to view and listen to content supplied by content providers via an internet connection through electronic devices such as a personal computer, PDA (Personal Digital Assistance), cellular phone, and the like. Additionally, in order to watch content more easily, patent document 1 discloses a display control method that allows enlarged and reduced displays of only images within an active window of an information processing device such as a personal computer.

Kokai (Jpn. unexamined patent publication) No. 17-70898

### SUMMARY OF THE INVENTION

### [Problems to Be Solved by the Invention]

Displaying the information other than relevant content simultaneously with such content, as well as enlarged and reduced displays of the content, are required. For instance, in recent years, digital televisions have been disseminated. And it is possible to obtain additional information simultaneously along with relevant content of TV programs and the like. In case that such technology is used, if products of sponsor companies of TV programs are shown on TV programs, more effects than ever that will be able to enhance advertising effects can be expected via the display of product advertisements simultaneously with relevant content. In order to realize the aforementioned matter, it is necessary to change the display format upon displaying relevant content.

### [Means for Solving the Problems]

In order to resolve the aforementioned issue, the present invention proposes the content delivery system with the content processing device obtains content information and interlocked icon information as interlocked icon information that is interlocked with the content displayed via the content information, retains a display section, which displays the content and the icon interlocked therewith in one area. And the content delivery system retains a function which changes display format of the display section. That is to say, the interlocked icon corresponds to an icon which shows that a modification of display format can be possible. In case that the content processing device receives signals which satisfy predetermined conditions from a remote control, cellular phone, PDA, and the like, if the interlocked icon is being displayed, a display format will be changed. In the case of changing of a display format, it is possible to display information regarding advertisement in an added new window as well as adoption of reduced display and the like.

### [Advantageous Effect of the Invention]

As mentioned above, the content delivery system according to the present invention comprises a display section that displays relevant content and an icon interlocked with the aforementioned content in one area. And if signals received in case that the interlocked icon is being displayed in the aforementioned display section satisfy given conditions, the content delivery system comprises a content processing device that changes the display format of the display section mentioned above. It is possible to view relevant content more easily and to display information other than such content by changing the display format. Furthermore, it is also possible to expect further effects that will allow more enhancement than ever of advertising effects via the display of relevant product advertisements of sponsor companies of television programs.

### BRIEF DESCRIPTION OF DRAWINGS

The present invention will become more fully understood from the detailed description given hereinbelow and the accompanying drawings which are given by way of illustration only, and thus are not limitative of the present invention, and wherein:

FIG. 1 is a functional block of the content delivery system related to the first embodiment;

FIG. 2 is a diagram which exemplifies a configuration of general computer;

FIG. 3 is a specific example of the section which acquires the information related to presence of icon display;

FIG. 4 is a specific example of the judgment section;

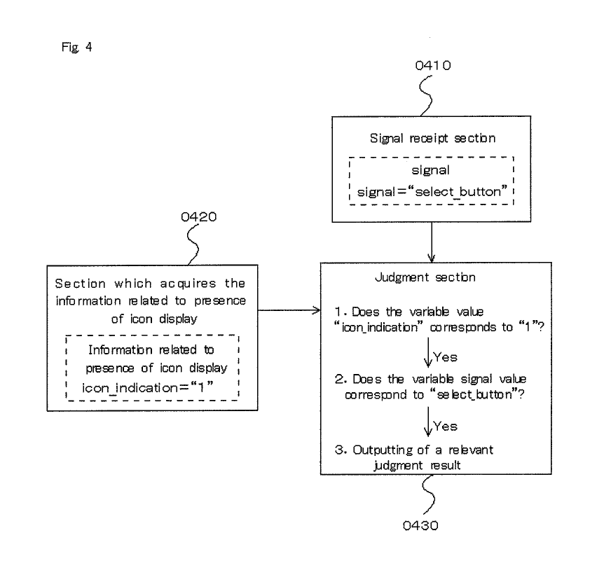

FIG. 5 is an example of modification of display format;

FIG. 6 is a flowchart which shows a processing flow of the content processing device related to the first embodiment;

FIG. 7 is a functional block of the content delivery system related to the second embodiment;

FIG. 8 is a flowchart which shows a processing flow of the content processing device related to the seconded embodiment;

FIG. 9 is a functional block of the content delivery system related to the third embodiment;

FIG. 10 is a specific example of the window;

FIG. 11 is an example of addition concerning a new window;

FIG. 12 is a functional block of the content delivery system related to the fourth embodiment;

FIG. 13 is an example of display concerning the information regarding advertisement;

FIG. 14 is a flowchart which shows a processing flow of the content processing device related to the fourth embodiment;

FIG. 15 is a functional block of the content delivery system related to the fifth embodiment;

FIG. 16 is a functional block of the content delivery system related to the seventh embodiment;

FIG. 17 is a specific example of the means for the superimposed icon;

FIG. 18 is a flowchart which shows a processing flow of the content processing device related to the seventh embodiment;

FIG. 19 is a functional block of the content delivery system related to the sixth embodiment;

FIG. 20 is a specific example of the section which stores the information regarding advertisement; and

FIG. 21 is a sequence diagram which shows a processing flow of the content processing device related to the sixth embodiment.

### EXPLANATION OF REFERENCES

0110 Content processing device

0111 Content information acquisition section

0112 Interlocked icon information acquisition section

0113 Display section

0114 Signal receipt section

0115 Section which acquires the information related to presence of icon display

0116 Judgment section

0117 Section which changes a display format

1310 Display section

1320 Content

1330 Interlocked icon

### DETAILED DESCRIPTION OF THE PREFERRED EMBODIMENTS

The preferred embodiments are explained hereinafter. The present invention is not limited by such embodiments. That is to say, the present invention can be implemented in various forms without deviating from the main purposes thereof.

### First Embodiment

### (Outline of First Embodiment)

According to the embodiment, the content delivery system comprises a display section that displays relevant content and an icon interlocked with the aforementioned content in one area. And if signals received in a case in which the interlocked icon is being displayed in the aforementioned display section satisfy predominated conditions, the content delivery system comprises a content processing device with a function that changes the display format of the display section mentioned above.

### (First Embodiment: Configuration)

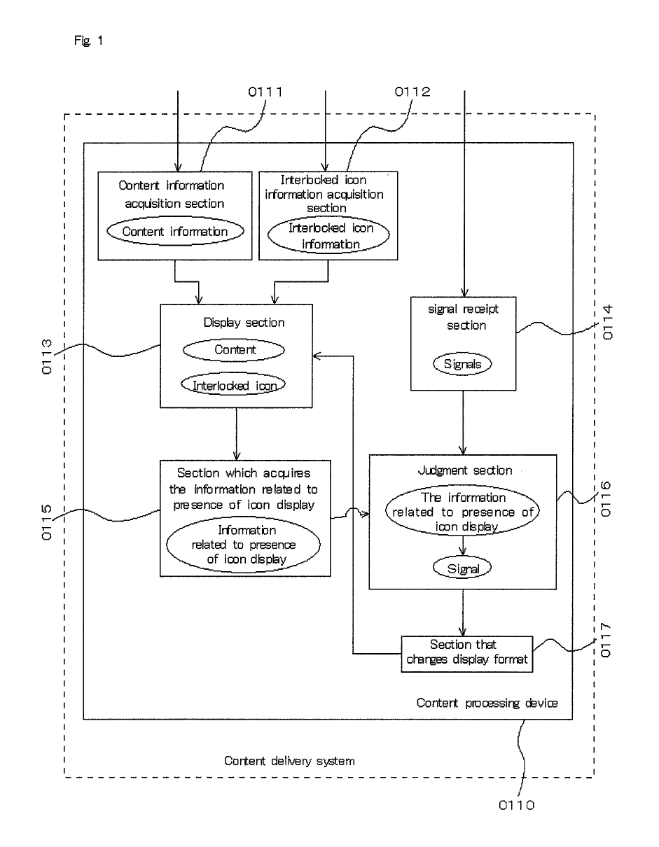

FIG. 1 is a functional block exemplifying the content delivery system of the embodiment. The content delivery system shown in FIG. 1 comprises a content processing device (0110). The aforementioned content processing device (0110) comprises a content information acquisition section (0111), an interlocked icon information acquisition section (0112), a display section (0113), signals receipt section (0114), a section that acquires the information related to presence of icon display (0115), a judgment section (0116), and a section that changes display format (0117). The aforementioned content processing device (0110) corresponds to general electronic devices that can receive relevant content via communication and display received content. For example, the aforementioned content processing device corresponds to a digital television, personal computer, cellular phone, PDA, and the like. The communication used to receive relevant content may depend on wired or wireless communication. In the case of wired communication, cable TV or wired network communication can be assumed. In the case of wireless communication, digital territorial broadcasting, digital satellite broadcasting, wireless network communication, or the like can be assumed. Additionally, the “content” here include images, sounds, music, and the like, and furthermore, refers to items that contain character information, application programs, and the like. That is to say, the content contains content signals that involve images, sounds, music, and the like, as well as information related to content signals. Specifically, for example, TV programs, EPG (Electronic Program Guide) TV program information and the like, animation content, and still image content that are distributed over a network apply.

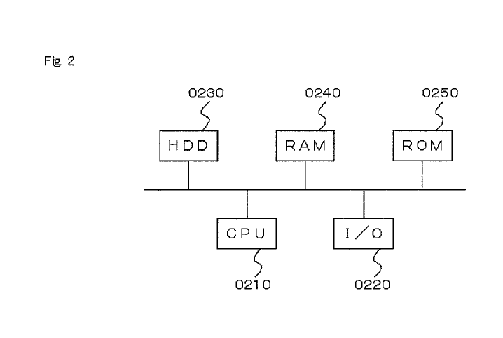

In addition, the sections as elements of the present invention comprise hardware, software, or both hardware and software. For instance, as an example that implements the aforementioned sections, in a case in which a computer is used, there exist hardware that comprises a CPU, bus, memory, interface, and peripheral devices, and software that can be executable on the above hardware. In regards to software, for a program deployed in the memory to be sequentially executed allows functions of the sections to be implemented due to data in the memory, processing, storage, or output of the data that will be inputted via the interface. Furthermore, more specifically, FIG. 2 is a diagram exemplifying a configuration of a general computer and that a computer is composed of a CPU (0210), an input-output interface (I/O) (0220), a hard disk (HDD) (0230), a RAM (0240), a ROM (0250), and the like. The content delivery system of the present invention will be implemented based on the same configuration as that of FIG. 2 (and the same applies throughout the entirety of the specification).

The content information acquisition section (0111) retains a function for acquisition of content information. The term “content information” refers to information that comprises content, and more specifically, to image data and the like. Additionally, content may be TV programs, in particular. Moreover, the content information may be obtained externally from broadcast stations, content providers, and the like and may be acquired internally from storage media inside the content processing device and the like. Also, a method for acquiring the content information may be via wired communication or wireless communication. In the case of wired communication, cable TV or wired network communication can be assumed. In the case of the wireless communication, digital territorial broadcasting, digital satellite broadcasting, wireless network communication, or the like can be assumed. In relation to specific processing of a content information acquisition section, for instance, implementation will be possible due to the fact that the image data that has been inputted via the input-output interface of a video input terminal or the like will be stored in a predetermined storage area such as an HDD, a RAM, or the like. Furthermore, the content information acquisition section may contain a program that causes the CPU to execute the aforementioned processing.

The interlocked icon information acquisition section (0112) retains a function that acquires interlocked icon information as interlocked icon information that is interlocked with the content displayed via the aforementioned content information. The “interlocked icon information” specifically corresponds to image data related to the interlocked icon. And the only information that shows whether or not the interlocked icon will be displayed in the display section described as below (0113) may be acceptable. Alternatively, the interlocked icon information may contain both the aforementioned information and image data. In the case of only information that shows whether or not the interlocked icon will be displayed in the display section described as below (0113), image data related to the interlocked icon can be assumed to be stored in a predetermined storage area such as an HDD, a RAM, or the like. Furthermore, in case that the interlocked icon is contained in the content in the content information acquisition section mentioned above (0111) and such information is obtained as one piece of image data, based on the content information obtained in the content information acquisition section mentioned above (0111), it is possible to judge whether the interlocked icon is displayed or not by scanning the OCR (Optical Character Reader) or the like. The term “information that shows whether to display or not” refers to the information related to presence of icon display detained as below, for instance. Also, it is acceptable for the timing of obtaining the content information in the content information acquisition section (0111) mentioned above and the timing of acquiring the interlocked information in the interlocked icon information acquisition section to differ from each other. In addition, interlocking related to a display of content and an interlocked icon will be described in the explanations of the display section (0113) below. Also, a method for acquiring the interlocked icon information may be via wired communication or wired communication. In the case of wireless communication, for instance, Bluetooth (registered trademark) invisible light, infrared rays or the like, or visible light may be acceptable. In relation to a specific processing of the interlocked icon information acquisition section, for instance, implementation will be possible due to the fact that the image data that has been inputted via the input-output interface of a video input terminal or the like will be stored in a predetermined storage area such as an HDD, a RAM, or the like. Furthermore, the interlocked icon information acquisition section may contain a program that causes a CPU to execute the aforementioned processing.

The display section (0113) retains a function that displays content and an icon interlocked with the aforementioned content in one area. The term “Interlocked with the content” mainly refers to a case in which the content will be displayed simultaneously when the content is displayed in the display section. However, it is possible that simultaneous display will not necessarily take place. For instance, a case in which the content is displayed first and then the interlocked icon is displayed thereafter applies. Moreover, in the case of simultaneous display, a case in which relevant information is combined in the form of a single image and a case in which relevant information is displayed by piling up separate images can be assumed. Due to simultaneous display of the content and interlocked icon, it is easy for content viewers to view the interlocked icons. Moreover, it is not necessary to separately establish a display mechanism of a display that displays the interlocked icon or the like. Thus, this method is convenient. Also, in case that the interlocked icon is being displayed, it is shown that a change of the display format of the display section is possible. As mentioned in details related to the judgment section (0116) below, in case that the aforementioned interlocked icon is being displayed and in case that the same is not, even if the signals received in the signal receipt section (0114) mentioned as below satisfy the predetermined conditions, it may be acceptable for the processing of the content processing device to be changed. For instance, in case that the aforementioned interlocked icon is not being displayed, even if a user pushes a remote control “enter” button, no execution will take place. On the other hand, in case that the aforementioned interlocked icon is being displayed, the display format will be changed in the display section in regards to the section which changes a display format (0117) mentioned below. The term “icon” refers to items that are expressed via characters or letters. And such icon is displayed as an image. And it is acceptable for such icon to be able to be clicked, dragged, dropped, or the like. The term “one area” means an arbitrary area. The term “area” refers to a scope of the location in which content is consecutively displayed. For instance, in case that the content is displayed over the entire window of a computer, the entire window will apply. In case that the content is displayed on a TV display, the portions of the display able to display the content will apply. The display section mainly corresponds to a display and the like. The type of display is not restricted to a specific type. Various features can be assumed, such as a TFT (Thin Film Transistor) liquid crystal display, an organic electroluminescence display, an inorganic electroluminescence display, a plasma display screen, a CRT (Cathode Ray Tube), and the like. In regards to processing in the display section, specifically, for instance, image data of the content interlocked icon stored in a predetermined storage area such as an HDD, a RAM, or the like via the content information acquisition section (0111) and the interlocked icon information acquisition section (0112) mentioned above will be read out from the predetermined area stored by a CPU and sent to a graphic card. Additionally, in case that the information shows whether the interlocked icon information stored in the predetermined area by the interlocked icon information acquisition section (0112) mentioned above is displayed in the display section (0113) instead of image data, if such information shows that the aforementioned information is displayed, it many be acceptable for the image data stored in the predetermined storage area to be separately read out. The image data sent to the graphic card is displayed in the graphic memory via a GPU (Graphic Processor Unit). Thereafter, as needed, such image data will be converted into a display output signal based on analog conversion and the like, and such data will be outputted to a display. Additionally, the display section may contain a program that causes the CPU to execute the aforementioned processing.

The signal receipt section (0114) retains the function which receives signals. Signals are assumed to be signals from a TV remote control, cellular phone, removable car navigation system, PDA, cordless handset of a telephone, and the like. More specifically, for instance, the signals are outputted when a button for changing a channel, a selection button, or a go button is being pushed down. A method for sending and receiving signals may depend on wired or wireless communication. In the case of wireless communication, for instance, Bluetooth (registered trademark) invisible light, infrared rays and the like, or visible light may be acceptable. Additionally, signals are assumed to be mainly outputted from outside the content processing device. Also, for instance, signals may be outputted from another processing mechanism inside the content processing device. In relation to processing at the signal receipt section, for instance, in case that signals are outputted from an infrared remote control, infrared rays will be received via an IR receiver module. Received signals contain information that shows what key of a remote control has been pushed. Thus, the result as to what key of a remote control has been pushed will be obtained and such resultant will be stored in a predetermined storage area. A system that receives infrared rays outputted from an infrared remote control is generally well known to the public. Thus, the detailed explanations regarding the same are omitted herein. Moreover, “the result as to what key of a remote control has been pushed” is expressed based on the data of “singal=”select_button,” for instance. “Signal” herein refers to a variable in the program as to what key has been pushed. That is to say, at such time, signals has been received and decrypted. Additionally, the signal receipt section may contain a program that causes a CPU to execute the aforementioned processing.

A section for acquiring information related to the presence of an icon display (0115) retains a function for obtaining information related to the presence of an icon display showing whether or not the aforementioned interlocked icon has been displayed in the display section mentioned above (0113). The information related to presence of icon display is expressed based on the data of “icon_indication=1,” for instance. The information “icon_indication=138 herein refers to a variable on the program as to whether the interlocked icon has been displayed or not. If this variable is “0,” the interlocked icon is not shown. And if this variable is “1,” the interlocked icon is shown.

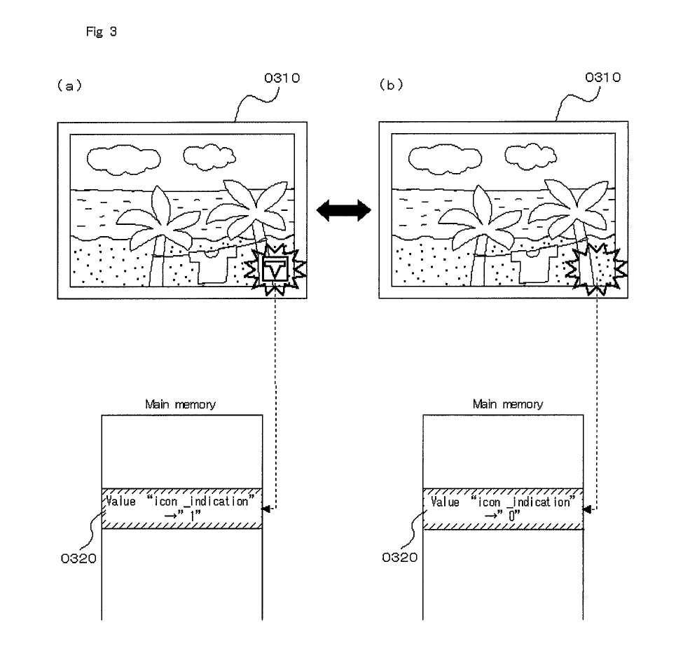

FIG. 3 is a concrete example concerning the section which acquires the information related to presence of icon display. For instance, as per (a), a variable value of icon_indication which has been stored in a predetermined area (0320) of main memory will be changed into “1” based on the fact that the interlocked icon has been displayed in the display section (0310)of content processing device as a trigger. And as per (b), a variable value of icon_indication which has been stored in a predetermined area (0320) of main memory will be changed into “0” based on the fact that the interlocked icon has been not displayed as a trigger. More specifically, for instance, the section which acquires the information related to presence of icon display contains the program which executes the aforementioned processing. And the program monitors whether the interlocked icon is being displayed in the display section or not at all times. As per (a), when the interlocked icon is being shown in the display section, the program will execute the processing which changes a variable value of icon_indication which has been stored in a predetermined area (0320) of main memory into “1” and will store the executed result in a predetermined area. Additionally, as per (b), in the same manner as the fact the interlocked icon is not being displayed in the display section, the program will execute the processing which changes a variable value of icon_indication which has been stored in a predetermined area of main memory into “0” and will store the executed result in a predetermined area.

When the information related to presence of icon display obtained by the section which acquires the information related to presence of icon display (0115) corresponds to the information to the effect that the aforementioned interlocked icon has been displayed in the display section (0113) mentioned above, the judgment section (0116) retains the function which judges whether the signal received by the signal receipt section (0114) mentioned above satisfies predetermined conditions or not. The term“ the information related to presence of icon display corresponds to the information to the effect that the aforementioned interlocked icon has been displayed in the display section mentioned above” specifically means that the aforementioned variable value of icon_indication corresponds to “1,” for example. The term “predetermined conditions” mean that signals, for instance, corresponds to the signals when a predetermined button of a remote-control unit in regards to content processing device has been pushed and the like. Specifically, expression is made based on the data “singal=”select_button.” Additionally, in regards to the section which changes a display format (0117) described as below, in case that the result of judgment in which the signal satisfies predetermined conditions applies, for example, if a button has been pushed, such button is assumed to be set up in advance at the content processing device so that a display format of the display section would be changed.

As a result of having the signal obtained at a signal receipt section (0410) decrypted, hypothetically, the result of “signal_select_button” has been obtained. In the same manner, hypothetically, the information “icon_indicaiton=″″” has been obtained as the information related to presence of icon display has been obtained by a section which acquires the information related to presence of icon display (0420). The judgment section (0430) judges whether the variable value “icon_indication” corresponds to “1” or not. Herein, the variable value “icon_indication” corresponds to “1.” Thus, a current processing is moved to the subsequent judgment processing. In relation to the subsequent judgment processing, it is judged whether a variable value of signal corresponds to “select_button” or not. Herein, the variable value of “signal” corresponds to “select_button.” Thus, the judgment results in which predetermined conditions are satisfied will be outputted. Furthermore, more specifically, for instance, the judgment section may contain the program which executes the processing mentioned above, and may give an order concerning the processing of reading out the variable value “icon_indication” from a predetermined area of main memory. In accordance with such order, CPU will read out a variable value “icon indication” from a predetermined area, will compare whether such value corresponds to “1” or not, and will store the compared result in a predetermined area. CPU will read out the compared result which has been stored. In case that the compared result corresponds to the information which shows that both of compared results are equal, a variable value “signal” will be read from a predetermined area. Moreover, the information which shows the aforementioned predetermined conditions is stored in such predetermined storage area of HDD, ROM, RAM, and the like of the content processing device. For instance, such information corresponds to the value “select_button.” CPU will read such information out from a predetermined storage area, will compare the same with the read variable value “signal,” and will store the compared result in the predetermined area. CPU will read the compared result out from a predetermined area, which has been stored. In case that the compared result corresponds to the information which shows that both of compared results are equal, the judgment result which satisfies the predetermined conditions in a predetermined area. Specifically, the term “judgment result” is expressed based on the data “decision=”1.” Herein, “decision” refers to a variable on the program which shows the judgment result. In case that such variable corresponds to “0,” it is shown that the predetermined conditions are not satisfied. And in case that such variable corresponds to “1,” it is shown that the predetermined conditions are satisfied. That is to say, at such time, the judgment result has been outputted.

In case that the judgment result corresponds to the fact that the judgment result by the aforementioned judgment section (0116) satisfies predetermined conditions, the section which changes a display format (0117) retains the function which changes a display format of the display section (0113) mentioned above. The expression “the fact that the judgment result satisfies predetermined condition” specifically means that the aforementioned variable value “decision” corresponds to “1,” for example. The term “c hanges a display format” means that a size of one area will be enlarged or reduced, or means that a new area will be added to the aforementioned display section (0113) and the like. Additionally, a size and location of each area when a display format is changed may not be constant. For instance, such size or location may be changed according to the content displayed in the display section. For example, in case that a new area is added, in regards to relevant content of the TV programs, if it is possible for a new area to be added so that a portion in which sponsor's product are shown would be avoided, an area can be added without hindering of displaying of relevant product, and such situation seems to be more preferred. Additionally, the information regarding the display format concerning a size and location of each area, and the like, may be stored inside the content processing device, or may be obtained from outside. For example, the information concerning display formant is stored classified by the content processing device in regards to an outside server, which supplies the information concerning display formant to the content processing device, it is possible for a current display formant to be changed into a suitable display format for each content processing device or each user concerning the relevant content processing device.

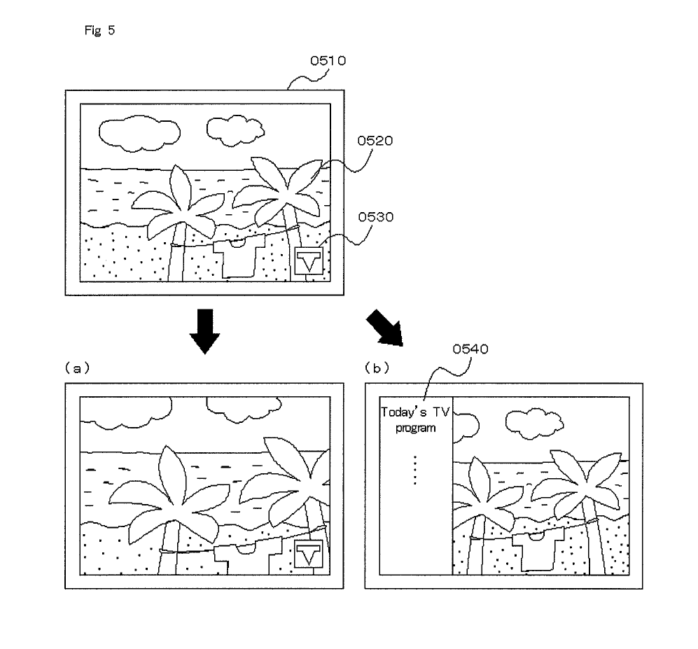

FIG. 5 is an example of modification of display format. As an initial condition, it is assumed that content (0520) and interlocked icon (0530) are being displayed in one area of the display section (0510). (a) and (b) correspond to a case where a display formant has been changed. (a) is an example when content has been enlarged. Additionally, under such condition, in case that signals is received under the condition that a button of remote control has been pushed down by a user of the content processing device, a more enlarged display may be allowed. Moreover, in regards to (b), a new area (0540) is added, and (b) shows an example when the information other than content displayed. The display magnification of content will be made as it is. And the portion in which a new area (0540) is added may be deleted and such resultant may be displayed. Alternatively, display may be made so that an entirety of the former content can be viewed. Moreover, in case that product of a sponsor company is displayed in the content, it is possible for a new area (0540) to be added so that a display of the product will not be hindered by storing the information as to where a portion in which the product of the sponsor company are displayed is located, and the like. Additionally, a new area (0540) may be an area in which nothing is shown. Furthermore, specifically, for instance, the section which changes a display format may contain the program which executes the aforementioned processing. And based on the condition that a variable value of indication which has been stored in a predetermined area of main memory has been changed into “1” as a trigger, the program may order CPU to read out the information (Such as a magnification percentage or reduction percentage of content and an additional location or size of an additional area) related to a modification of display format which has been stored in a predetermined storage area such as an HDD, a RAM, or the like In accordance with the order, CPU will read out the relevant information from a predetermined storage area. Additionally, image data regarding the content that are being displayed will be read out from a predetermined area. And based on the resultant information related to a modification of display format which has been read as above, the processing concerning the image data for enlargement, reduction, and cutout of the image will be executed and edition will be made. Additionally, as needed, image data in regards to the information which will be displayed in a new area which has been stored in a predetermined area will be read out, and the processing of combining of such data and the edited image data above will be executed. When image data concerning the relevant content the aforementioned display section is obtained, the image data in regards to the information which will be displayed in a new area may be obtained simultaneously linked by the image data concerning the relevant content. Alternatively, the image data in regards to the information which will be displayed in a new area may be obtained from outside, and the like, based on the fact that a new area has been added, as a trigger. The image data created as such will be deployed to a graphic memory by GPU. Thereafter, such data will be converted into a display output signal based on an analog conversion as needed, and such resultant will be outputted to a display.

### (Processing Flow of the First Embodiment)

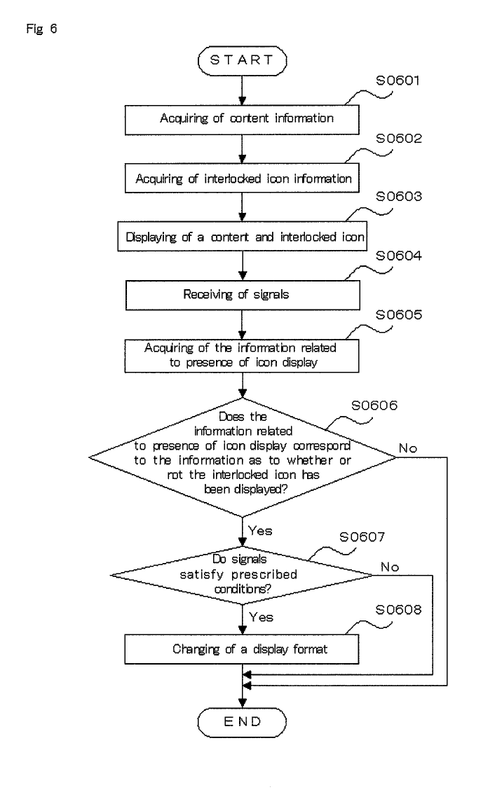

FIG. 6 is a flowchart which shows a processing flow in regards to the content delivery system of the embodiment.

Initially, the content information will be obtained. Such processing will be executed by the content information acquisition section (Step for acquiring of content information: S0601).

Subsequently, the interlocked icon information will be obtained. Such processing will be executed by the interlocked icon information acquisition section (Step for acquiring of interlocked icon information: S0602).

Next, content and interlocked icon therewith will be displayed in one area. Such processing will be executed by the display section (Display step: S0603).

Then, signals will be received. Such processing will be executed by the signal receipt section (Step for signal receipt: S0604).

Next, the information related to presence of icon display showing whether or not the interlocked icon has been displayed in the display step (S0603) mentioned above will be obtained. Such processing will be executed by the section which acquires the information related to presence of icon display (step for acquiring of the information related to presence of icon display: S0605)

Subsequently, it is judged whether or not the information related to presence of icon display obtained through the step for acquiring of the information related to presence of icon display mentioned above corresponds to the information as to whether or not the interlocked icon has been displayed through the display step (S0603) mentioned above. n case that the judgment herein is made which such information corresponds to the effect that the interlocked icon has been displayed, the step for signal judgment (S0607) described as below will be chosen. In case that the judgment herein is made which such information corresponds to the effect that the interlocked icon has not been displayed, the processing will be ended. Such processing will be executed by the judgment section (Step for judging of presence of icon display: S0606).

Subsequently, in case that it is judged that the judgment result by the step for judging of presence of icon display (S0606) has corresponded to the information to the effect that the interlocked icon has been displayed, it will be judged whether or not signals received through the step for signal receipt (S0604) mentioned above satisfies predetermined conditions. In case that the judgment herein is made to the effect that predetermined conditions have been satisfied, a step will be moved to the step for changing a display format (S 0608)described as below. In case that the judgment herein is made to the effect that predetermined conditions have not been satisfied, such processing will be executed by the judgment section (Step for signal judgment: S0607).

Finally, in case that the step for signal judgment (S 0607) mentioned above has made to the effect that prescribed conditions have been satisfied, a display format of the aforementioned display step (S0603) will be changed. Such processing will be executed based on the section which changes a display format (the step for changing a display format: S0608).

### (Effect of the First Embodiment)

The content processing device of the content delivery system of the embodiment retains the display section which displays the aforementioned content and interlocked icon therewith in one area. And in case that signals received when the interlocked icon are being displayed in the display section mentioned above satisfy predetermined conditions, the content processing device retains the function which changes a display formant of the display section mentioned above. It is possible to view relevant content more easily and to display the information other than the content via changing a display format. Furthermore, it is also possible to expect more effects which will be able to enhance advertising effects than ever via displaying relevant product advertisements of sponsor companies of television programs

### Second Embodiment

### (Outline of the Second Embodiment)

The embodiment relates to the content delivery system with a button, which further retains the remote-control unit with the function to output signals which satisfy the aforementioned predetermined conditions by being interlocked with pushing down of a button, in addition to the function regarding the content processing device related to the first embodiment.

### (Configuration of the Second Embodiment)

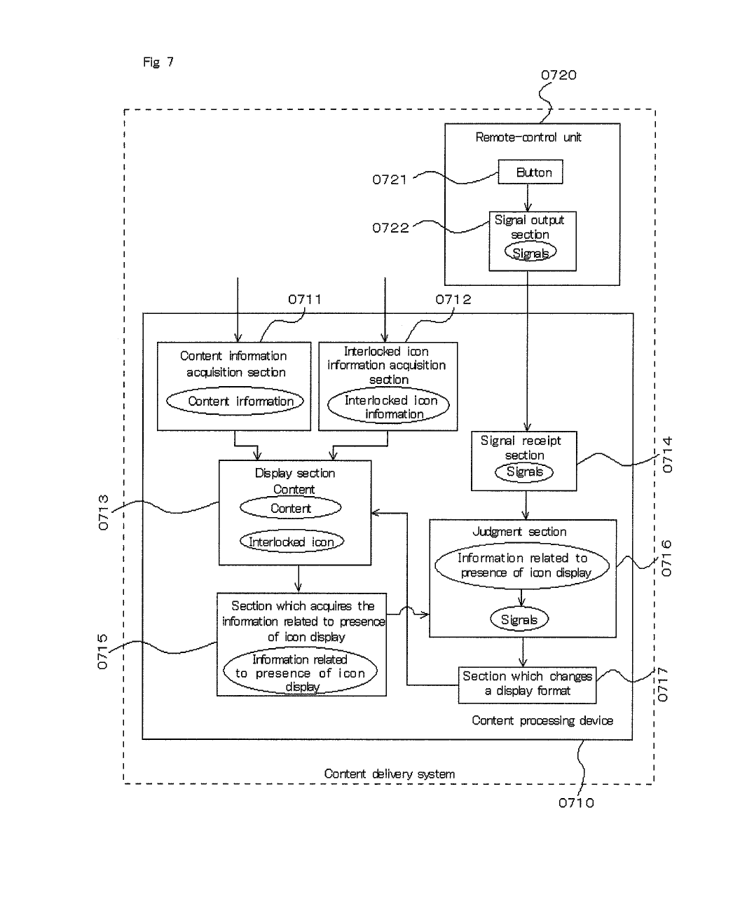

FIG. 7 is a functional block regarding the content delivery system related to the embodiment. The content delivery system shown in FIG. 7 retains a content processing device (0710) and the remote-control unit (0720). The content processing device (0710) retains a content information acquisition section (0711), an interlocked icon information acquisition section (0712), a display section (0713), a signal receipt section (0714), a section which acquires the information related to presence of icon display (0715), a judgment section (0716), and a section which changes a display format (0717). The configuration of the content processing device (0710) mentioned above is the same as that of the content processing device related to the first embodiment. Thus, the explanations thereof are omitted hereinafter. The aforementioned remote-control unit (0720) retains a button (0721) and a signal output section (0722). It is acceptable for the aforementioned remote-control unit (0720) to correspond to electronics equipment which allows signals to be outputted in regards to the content processing device (0710) mentioned above. Specifically, for instance, remote control of TV, cellular phone, removable car navigation system, PDA, and cordless handset of a telephone, and the like, applies.

The button (0721), for example, may be a mechanical button of a button of TV's remote control or key of cellar phone, and the like. Alternatively, as long as the remote-control unit retains a display with a touch panel, the button may be a button which can be shown in a display and can be operated by being touched and selected via a touch panel, and the like.

The signal output section (0722) retains the function which outputs signals satisfying the aforementioned predetermined conditions in conjunction with pushing down of the button (0721) mentioned above. The term “pushing down of the button” means that in case that the aforementioned button corresponds to a mechanical button, such button will be pushed down, and the like. On the other hand, for example, in case that the aforementioned button (0721) corresponds to a button shown in a display with touch panel, “pushing down of the button” means that such button will be touched via a touch panel and be selected. The term “outputs signals satisfying the aforementioned predetermined conditions in conjunction with pushing down of the button mentioned above” means that signals satisfying the aforementioned predetermined conditions is outputted under the condition that the aforementioned button (0721) has been pushed down as a trigger. Additionally, the destination for signals to be outputted will mainly correspond to the content processing device (0710) mentioned above. However, such signal may be outputted indirectly via other electronics equipment rather than being outputted directly. Moreover, a method for communicating of signals may depend on wired or wireless communication. In the case of wireless communication, for instance, Bluetooth (registered trademark) invisible light, infrared rays and the like, or visible light may be acceptable. In regards to the processing of the signal output section, for instance, in case that the aforementioned remote-control unit (0720) corresponds to a infrared remote control, signals corresponding to the pushed button will be outputted via an infrared ray based on the fact that the aforementioned button (0721) has been pushed down as a trigger. A system for an infrared ray to be outputted from an infrared remote control is generally well known to the public. Thus, the detailed explanations will be omitted hereinafter.

### (Processing Flow of the Second Embodiment)

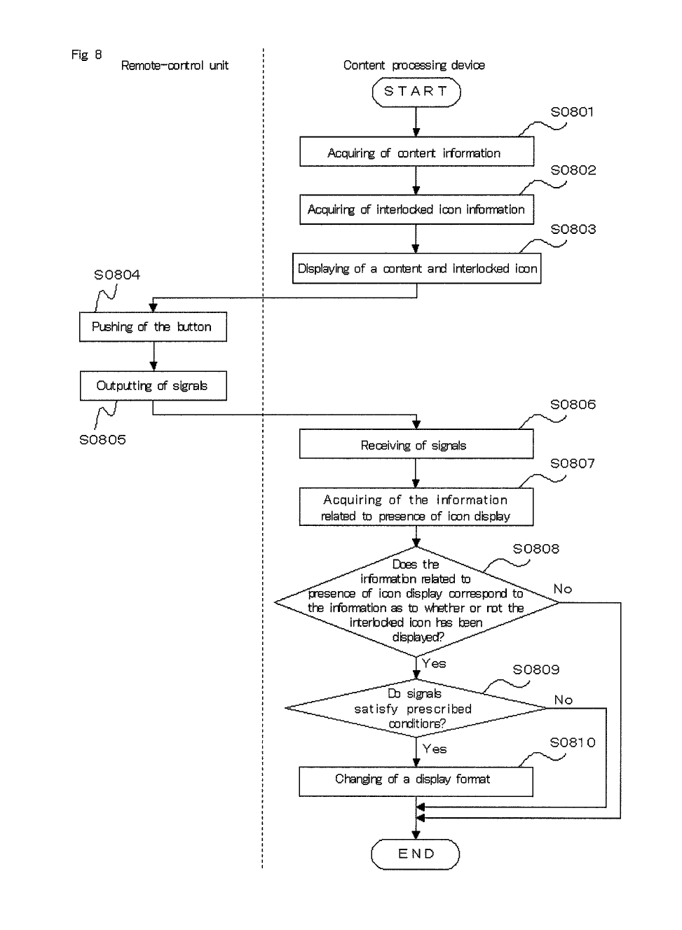

FIG. 8 is a flowchart which shows a processing flow of the content delivery system of the embodiment.

In the beginning, the content processing device obtains the content information. Such processing will be executed by the content information acquisition section (Step for acquiring of content information: S0801)

Subsequently, the interlocked icon information will be acquired. Such processing will be executed by the interlocked icon information acquisition section (Step for acquiring of interlocked icon information: S0802).

Next, content and interlocked icon therewith are displayed in one area. Such processing will be executed by the display section (display step: S0803).

Then, a button is pushed via the remote-control unit. Such processing will be executed by the button (Step for pushing of the button: S0804).

Subsequently, signals satisfying the predetermined conditions are outputted in conjunction with pushing down of a button which has been executed through the step for pushing of the button (S0804) mentioned above is outputted. Such processing will be executed by the signal output section (Step for outputting of signals: 0805)

Then, signals which have been outputted through the step for outputting of signals (S0805) mentioned above will be received by the content processing device. Such processing will be executed by the signal receipt section (Step for signal receipt: S0806).

Next, the information related to presence of icon display which shows whether or not the interlocked icon is being displayed through the display step (S0803) mentioned above will be obtained. Such processing will be executed by the section which acquires the information related to presence of icon display (Step for acquiring of the information related to presence of icon display: S0807).

Subsequently, it is judged whether or not the information related to presence of icon display obtained through the step for acquiring of the information related to presence of icon display (S0807) mentioned above corresponds to the information that the interlocked icon is being displayed at the aforementioned display step (S0803). Herein, in case that it is judged that the information related to presence of icon display corresponds to the information that the interlocked icon is being displayed, a step will be moved to the step for signal judgment (S0809). Herein, in case that it is judged that the information related to presence of icon display does not correspond to the information that the interlocked icon is being displayed, the processing will be ended. Such processing will be executed by the judgment section (Step for judging of presence of icon display: S0808).

Next, in case that it is judged that the judgment result by the step for judging of presence of icon display (S0808) mentioned above corresponds to the information as to whether or not the interlocked icon has been displayed, it will be judged whether or not signals received through the step for signal receipt (S0806) mentioned above satisfy predetermined conditions. In case that the judgment herein is made to the effect that predetermined conditions have been satisfied, a step will be moved to the step for changing a display format (S0810) described as below. In case that the judgment herein is made to the effect that predetermined conditions have not been satisfied, such processing will be ended. Such processing will be executed by the judgment section (Step for signal judgment: S0809).

Finally, in case that it is judged that the judgment result has satisfied the predetermined conditions through the step for signal judgment (S0809) mentioned above, a display formant through the display step (S0803) mentioned above is changed. Such processing will be executed by the section which changes a display format (Section which changes a display format: S0810).

### (Effect of the Second Embodiment)

The content delivery system of the embodiment retains a button and further retains a remote-control unit with the function which outputs signals satisfying the predetermined conditions mentioned above in conjunction with pushing down of the aforementioned button, in addition to the function of the content delivery system related to the first embodiment. Due to this, based on signals outputted from the remote-control unit, it is possible to change a display format of the above-mentioned display section.

### Third Embodiment

### (Third Embodiment: Outline)

The embodiment relates to the content delivery system in which the section which changes a display format retains the function to add a new window to the aforementioned display section as a modification of a display format, in addition to the function of the content delivery system related to the first or second embodiments.

### (Third Embodiment: Structure)

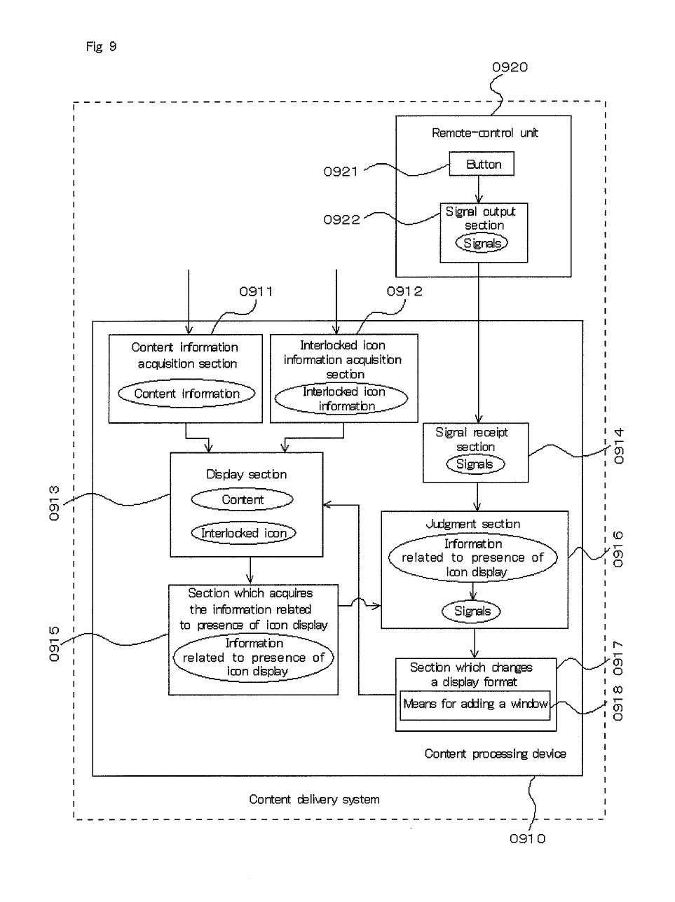

A functional block regarding the content delivery system of the embodiment is illustrated in FIG. 9. A configuration of the content delivery system of the embodiment corresponds to a configuration in which a means for adding a window (0918) is added to a configuration of the content delivery system related to the first or second embodiments. In FIG. 9, a configuration in which the above-mentioned means for adding a window (0918) is added to a configuration of the content delivery system related to the second embodiment is exemplified. The content delivery system retains the content processing device (0910) and the remote-control unit (0920). The content processing device (0911), the interlocked icon information acquisition section (0911), the interlocked icon information acquisition section (0912), the display section (0913), the signal receipt section (0914), the section which acquires the information related to presence of icon display (0915), the judgment section (0916), and the section which changes a display format (0917). Additionally, the section which changes a display format (0197) retains the means for adding a window (0918). Moreover, the above-mentioned remote-control unit (0922) retains the button (0921) and the signal output section (0922).

The means for adding a window (0918) retains the function which adds a new window to the aforementioned display section (0913) as a modification of a display formant. A window refers to an area in which content and information and the like can be displayed.

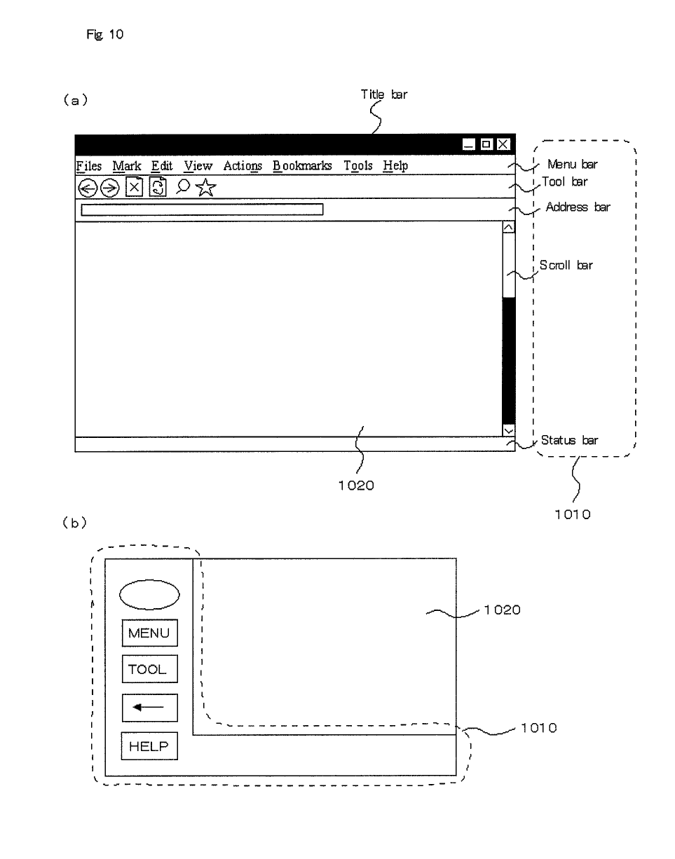

FIG. 10 is a concrete example of window. (a) shows an example of window in regards to a general computer terminal unit. And (b) shows an example of window in regards to a digital television with the internet access function. The area 1010 corresponds to an area including the functional buttons, etc. in order to control a window itself. And the area 1020 corresponds to an area which displays relevant content, information, and the like. A window is roughly divided into the area 1010 and the area 1020. Additionally, as per 0540 of FIG. 5(b), a window which comprises only a borderline of the area may be acceptable. Moreover, a shape of window does not have to be rectangular shaped of 0540 in FIG. 5(b). For example, a shape of L-shape or laterally-facing squared U-shape window may be acceptable. Furthermore, new windows can be multiple. For instance, two windows may be added so that such windows would pinch the area where content is displayed. Also, piled multiple windows may be displayed. And a size, shape, or location of window may not be fixed. For example, a window may be changed according to the content that is shown in the display section. The information regarding a size, shape, or location of window may be stored inside the content processing device or may be obtained from outside. For instance, in case that the window information is stored classified by the content processing device via an external server which supplies the window information to the content processing device, it is possible to add a window which is suitable for the classification of content processing device or of user of content processing device. Also, it is acceptable that no information is shown on a new window. Furthermore, for instance, relevant information may be displayed or not displayed depending on the progress of content.

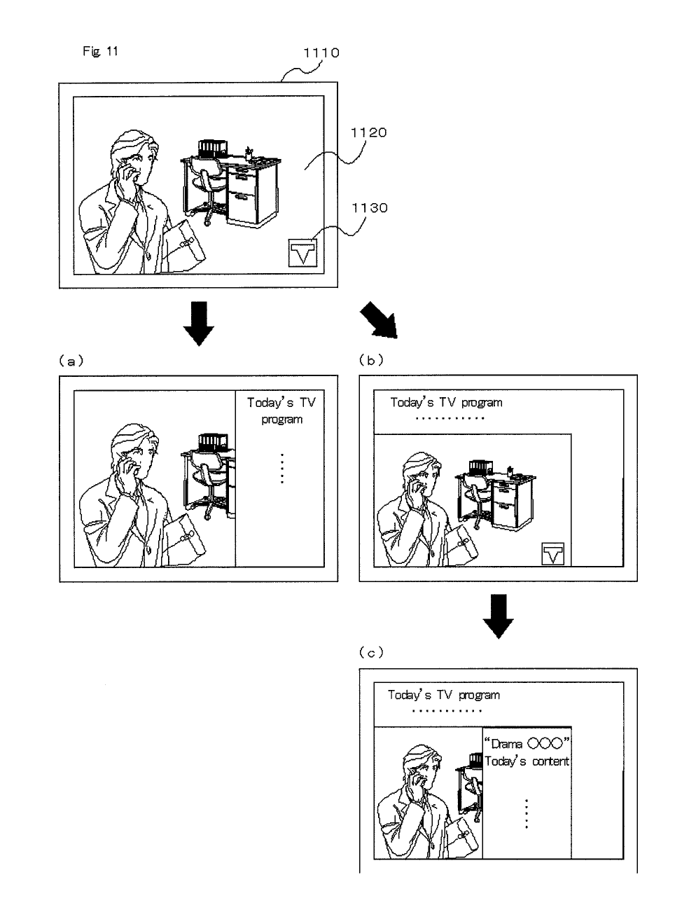

FIG. 11 is an additional example of new window. Hypothetically, as an initial condition, drama content 1120) and interlocked icon (1130) are being shown in one area of the display section (1110). (a), (b), and (c) shows the example when a new window has been added. As for (a), one new window has been added, content is displayed in an original area based on the original display magnification, and information related to broadcasting programs is displayed on a new window. In case that a product of a sponsor company is being displayed in relevant content and the information related to a location concerning the portion in which the product of the sponsor company in the drama program has been displayed in an area should be stored. Due to this, a new window will be added so that a new window would not hinder a display of the product. This method seems to be more preferred. Additionally, as for (b), horizontal to vertical ratio regarding the original content 1120) and interlocked icon (1130) is kept, and reduced display is made. And a new window is added so that such new window would surround the display area of the content involving reduced display. Due to this, relevant information is displayed. In such case, a display of content when a new window is added will not be hindered. Thus, in case that a size and location of the area to which a new window is added is determined, it is possible to add a new window in the same manner at all times. Also, the interlocked icon is displayed. Therefore, it may be possible for the information to be shown by adding a new window as per (c). Furthermore, specifically, for instance, the means for adding a window may contain the program which executes the aforementioned processing. And based on the condition that a variable value “decision” which has been stored in a predetermined area of main memory has been changed as a trigger, the program may order CPU to read out the information of a size or additional location of a new window which has been stored in a predetermined storage area such as an HDD, a RAM, or the like and image data of a functional button which comprises a window in case that a pattern of window corresponds to a pattern of (a) and (b) of FIG. 10. CPU reads out the information from the predetermined storage area in accordance with the order. Additionally, image data regarding the content which are being displayed will be read out from a predetermined area. And according to the read information such as a size and the like, deletion of unnecessary image data will be executed and edition will be made. Also, as needed, image data in regards to the information shown on a new window, which has been stored in a predetermined area, is read out. When image data concerning the relevant content the aforementioned display section is obtained, the image data in regards to the information may be obtained simultaneously linked by the image data concerning the relevant content. Alternatively, the image data in regards to the information may be obtained from outside, and the like, based on the fact that a new area has been added, as a trigger. The image data in regards to the information shown on a new window and image data in regarding the edited content combined, and the image data which can be displayed in the display section mentioned above is created. The image data created as such will be deployed to a graphic memory by GPU. Thereafter, such data will be converted into a display output signal based on an analog conversion as needed, and such resultant will be outputted to a display.

### (Processing Flow of the Third Embodiment)

A processing flow of the content delivery system of the embodiment is the same as that of the content delivery system of the first or second embodiments. However, in regards to the step for changing a display format mentioned above, when a display format is changed in regards to the display step, there exist characteristics where a new window is added as a modification of display formant.

### (Effect of the Third Embodiment)

In regards to the content delivery system of the embodiment, the section which changes a display format retains the function to add a new window to the aforementioned display section as a modification of display format. Due to this, it is also possible to supply more useful information to content viewers by showing further information on a new window.

### Fourth Embodiment

### (Outline of the Fourth Embodiment)

In addition to the function of the content delivery system related to the third embodiment, when a new window has been added via the aforementioned means for adding a window, the embodiment relates to the content delivery system with the function which starts communications, obtains the information regarding advertisement, and displays the obtained information regarding advertisement to the means for adding a window mentioned above.

### (Configuration of the Fourth Embodiment)

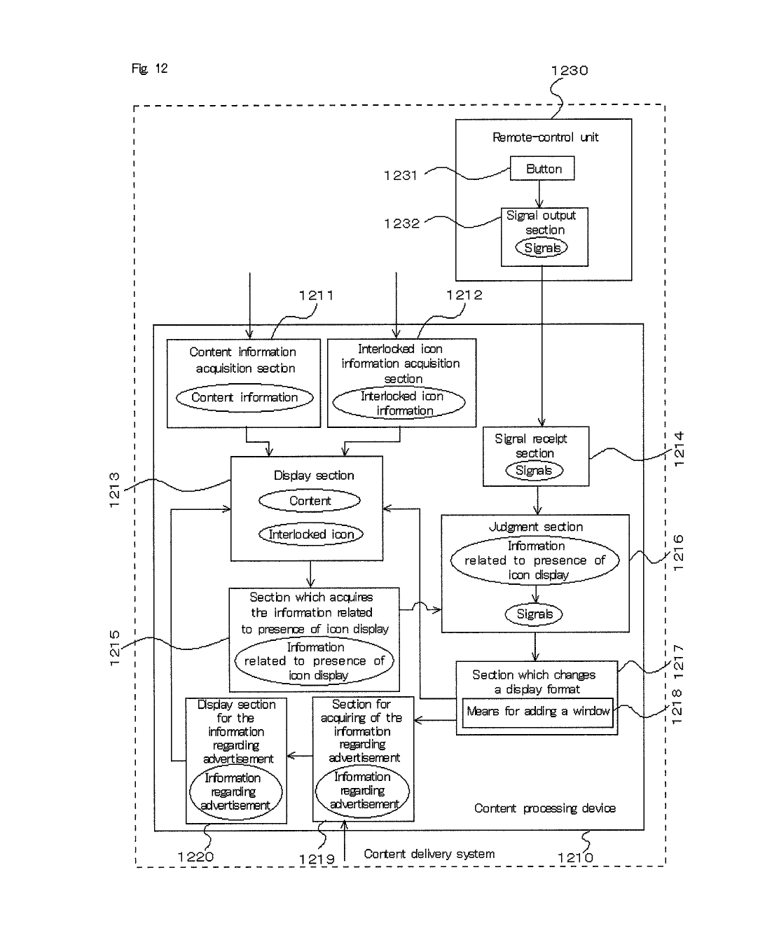

FIG. 12 is a functional block concerning the content delivery system of the embodiment. A configuration of the content delivery system of the embodiment is a configuration in which a section for acquiring of the information regarding advertisement (1219) and display section for the information regarding advertisement (1220) are added to a configuration of the content delivery system related to the third embodiment. The content delivery system retains the content processing device (1210) and the remote-control unit (1230). The content processing device (1210) retains a content information acquisition section (1211), an interlocked icon information acquisition section (1212), a display section (1213), a signal receipt section (1214), a section which acquires the information related to presence of icon display (1215), a judgment section (1216), a signal receipt section (1214), a section which acquires the information related to presence of icon display (1215), a judgment section (1216), a section which changes a display format (1217), a section for acquiring of the information regarding advertisement (1219), and a display section for the information regarding advertisement (1220). Additionally, the section which changes a display format (1217) retains the means for adding a window (1218). Moreover, the aforementioned remote-control unit (1230) retains the button (1231) and the signal output section (1232).

When a new window has been added via the means for adding a window (1218) mentioned above, the section for acquiring of the information regarding advertisement (1219) retains the function which starts communications and obtains the information regarding advertisement. That is to say, the section for acquiring of the information regarding advertisement acquires the information regarding advertisement base on the fact that the new window has been added via the means for adding a window (1218) mentioned above as a trigger. An obtaining party may be an outside party of the content processing device or may be an internal party thereof. The tem the information regarding advertisement” corresponds to the information regarding advertisement of commercials and PR, and the like. More specifically, the information with the nature of an introduction of company, product, and service, and the like applies. The information regarding advertisement may be animation images or may be still images. In case that the information regarding advertisement corresponds to the information regarding advertisement related to relevant content which are shown in the display section in particular, it seems that the advertisement effect will be more increasingly enhanced. For instance, according to a timing when a new window has been added, it would be more useful if the information regarding advertisement which will be displayed based on the scenes of content changed, and the like. The term “the information regarding advertisement related to relevant content corresponds to the information regarding advertisement relating to a product of sponsor company concerning relevant content or the information regarding advertisement relating to a product displayed in relevant content in regards to acquiring of the information regarding advertisement, for instance, based on the fact that upon obtaining the content information via the content information acquisition section (1211) mentioned above, the information linked to an obtaining party involving the information regarding advertisement is simultaneously obtained, a method for connecting an obtaining party which is shown in the link information and for obtaining the information regarding advertisement, and the like, can be possible, under the condition that a new window has been added to the means for adding a window (1218) as a trigger. Furthermore, more specifically, for instance, the section for acquiring of the information regarding advertisement contains the program which executes the aforementioned processing. And based on the condition that a new window which has been stored in a predetermined area of main memory has been added (or a variable value of indication which has been stored in a predetermined area of main memory has been changed as a trigger may be acceptable) as a trigger, the program may order CPU to read out the information linked to an obtaining party involving the information regarding advertisement which has been stored in the predetermined storage area such as an HDD, a RAM, or the like. In accordance with such order, CPU will read out the link information from a predetermined storage area. Based on the read link information and the like, I/O, such as a network card, connection to an obtaining party involving the information regarding advertisement is executed. When such connection becomes successful, downloading the information regarding advertisement is executed via the communications, and such information is stored in a predetermined storage area. That is to say, at such time, the information regarding advertisement has been obtained. Additionally, in case that the information regarding advertising associated with relevant content obtained, the information regarding advertising associated with relevant content will be simultaneously obtained upon obtaining the content well, and such information will be stored in a predetermined storage area. For instance, according to a timing when a new window has been added, in case that the information regarding advertisement to be displayed based on relevant scenes is changed, scene numbers and identifies for the information regarding advertisement to be displayed in such scenes will be associated, and such resultant will be stored in a predetermined storage area as the database, and the like. The information regarding advertisement which will be displayed based on the scenes of content changed, and the like. Thereafter, at the time when a new window has been added, the identifies for the information regarding advertisement associated with the scenes will be checked from the database, and the like, and the information regarding advertisement will be obtained from an obtaining party involving the information regarding advertisement via the read identifiers.

The display section for the information regarding advertisement (1220) retains the function which display the information regarding advertisement obtained via the section for acquiring of the information regarding advertisement (1219) on a new window which has been added via the means for adding a window (1218) mentioned above. Any time will be acceptable in regards to a timing when the information regarding advertisement is being displayed on a new window, as long as such timing comes after a new window has been added. For instance, such timing may be the time after a new window has been added or the time when the information regarding advertisement is displayed via designation of the time by content viewers from time to time, and the like.

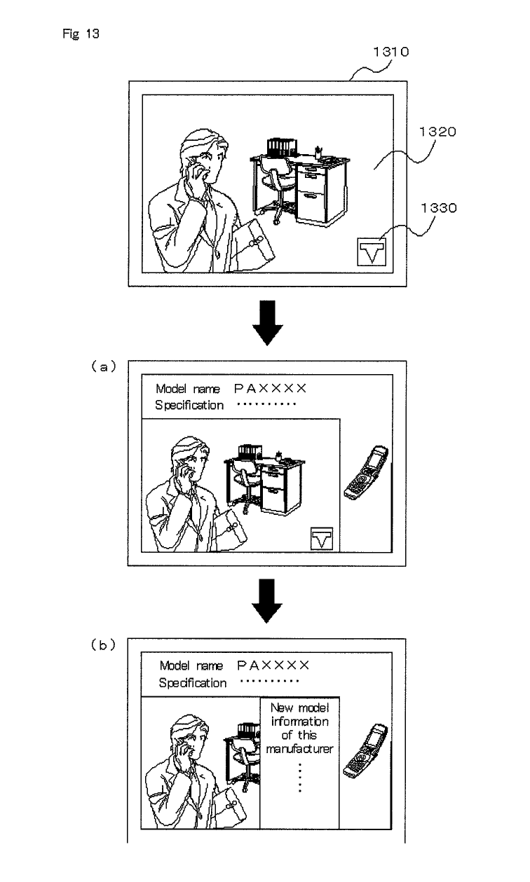

FIG. 13 is an example of display of the information regarding advertisement. Hypothetically, as an initial condition, drama content (1320) and interlocked icon (1330) are being shown in one area of the display section (1110). In FIG. 13(a), in regards to the means for adding a window, horizontal to vertical ratio regarding the original content (1320) and interlocked icon (1330) is kept, and reduced display is made. And a new window is added so that such new window would surround the display area of the content involving reduced display. Due to this, relevant information is displayed. For instance, the information related to a cellular phone of a program sponsor company held by a character in the drama of this new window is displayed as the information regarding advertisement. The information regarding advertisement does not always have to be associated with the displayed content. However, when the information regarding advertisement associated with the content is displayed, it is highly possible for such information to draw attentions of viewers who are watching such content. It seems that the advertisement effect will be enhanced more increasingly. Furthermore, as per FIG. 13(b), due to adding a new window, it may be acceptable to display detailed information. Furthermore, specifically, for instance, the processing of the display section for the information regarding advertisement mentioned above may contain the program which may order CPU to read out the information regarding advertisement which has been stored in a predetermined area by the section for acquiring of the information regarding advertisement, the information concerning a size or additional location of a new window from a predetermined storage area, and image data of a functional button which comprises a window. In accordance with such order, CPU will read out such information from a predetermined area, will execute an image processing for displaying the information regarding advertisement based on the read information, and will store the same in a predetermined storage area. Thereafter, the information regarding advertisement will be displayed on a new window based on the processing by the display section mentioned above.

### (Processing Flow of the Fourth Embodiment)

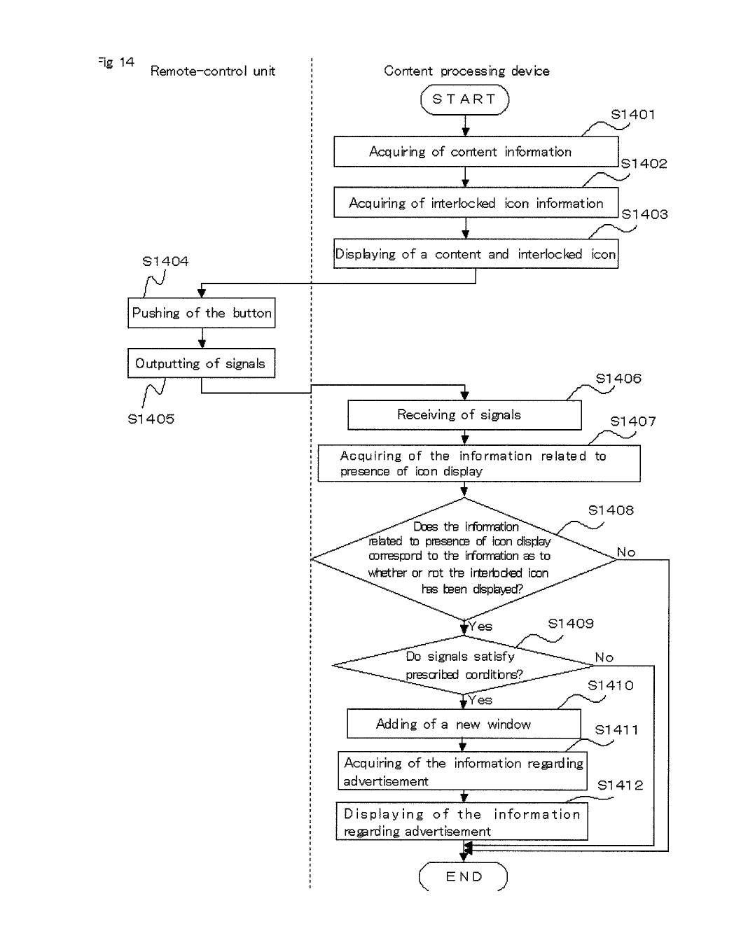

FIG. 14 is a flowchart which shows a processing flow of the content delivery system of the embodiment.

Initially, content information will be acquired through the content processing device. Such processing will be executed by the content information acquisition section (Step for acquiring of content information: S1401).

Then, interlocked icon information will be acquired. Such processing will be executed by the interlocked icon information acquisition section (Step for acquiring of interlocked icon information: S1402).

Subsequently, content and interlocked icon therewith are displayed in one area. Such processing will be executed by the display section (display step: S1403).

Then, a button is pushed via the remote-control unit. Such processing will be executed by the button (Step for pushing of the button: S1404).

Subsequently, signals satisfying the predetermined conditions are outputted in conjunction with pushing down of a button which has been executed through the step for pushing of the button (S1404) mentioned above is outputted. Such processing will be executed by the signal output section (Step for outputting of signals: S1405).

Then, signals which have been outputted through the step for outputting of signals (S1405) mentioned above will be received by the content processing device. Such processing will be executed by the signal receipt section (Step for signal receipt: S1406).

Next, the information related to presence of icon display showing whether or not the interlocked icon has been displayed in the display step (S1403) mentioned above will be obtained. Such processing will be executed by the section which acquires the information related to presence of icon display (Step for acquiring of the information related to presence of icon display: S1407)

Subsequently, it is judged whether or not the information related to presence of icon display obtained through the step for acquiring of the information related to presence of icon display (S1407) mentioned above corresponds to the information as to whether or not the interlocked icon has been displayed through the display step (S1403) mentioned above. In case that the judgment herein is made which such information corresponds to the effect that the interlocked icon has been displayed, the step for signal judgment (S1409) described as below will be chosen. In here, in case that it is judged that the information related to presence of icon display does not correspond to the information that the interlocked icon is being displayed, the processing will be ended. Such processing will be executed by the judgment section (Step for judging of presence of icon display: S1408).

Next, in case that it is judged that the judgment result by the step for judging of presence of icon display (S1408) mentioned above corresponds to the information as to whether or not the interlocked icon has been displayed, it will be judged whether or not signals received through the step for signal receipt (S1406) mentioned above satisfy predetermined conditions. In case that the judgment herein is made to the effect that predetermined conditions have been satisfied, a step will be moved to the step for adding a window (S1410) described as below. In case that the judgment herein is made to the effect that predetermined conditions have not been satisfied, such processing will be ended. Such processing will be executed by the judgment section (Step for signal judgment: S1409).

Next, in case that it is judged that the judgment result has satisfied the predetermined conditions through the step for signal judgment (S1409) mentioned above, a new window will be added as a modification of display format through the display step (S1403) mentioned above. Such processing will be executed by the means for adding a window (the step for adding a window: S1410).

Subsequently, when a new window has been added via the step for adding a window (1410) mentioned above, the information regarding advertisement will be acquired via starting of communications. Such processing will be executed by the section for acquiring of the information regarding advertisement (Step for acquiring of the information regarding advertisement: S1411).

Finally, the information regarding advertisement obtained through the step for acquiring of the information regarding advertisement (S1411) mentioned above is displayed on a new window which has been added by the step for adding a window (1410) mentioned above. Such processing will be executed by the display section for the information regarding advertisement (Step for displaying of the information regarding advertisement: S1412).

### (Effect of the Fourth Embodiment)

In addition to the function of the content delivery system of the third embodiment, when a new window has been added via the aforementioned means for adding a window, the embodiment relates to the content delivery system with the function which starts communications, obtains the information regarding advertisement, and displays the obtained information regarding advertisement which has been added by the means for adding a window mentioned above on a new window. Due to this, it is also possible to supply the useful information regarding advertisement to content viewers. Furthermore, when the information regarding advertisement is displayed in association with the displayed content in the display section, it is expected that advertisement effect will be enhanced more increasingly.

### Fifth Embodiment

### (Outline of the Fifth Embodiment)

In addition to the function of the content delivery system related to the fourth embodiment, the embodiment relates to the content delivery system with the function which stores the information regarding equipment identification as the information in order to physically identify the content processing device. And the content delivery system is characterized by the section for acquiring of the information regarding advertisement which obtains the aforementioned information regarding advertisement based on the stored information regarding equipment identification.

### (Fifth Embodiment: Structure)

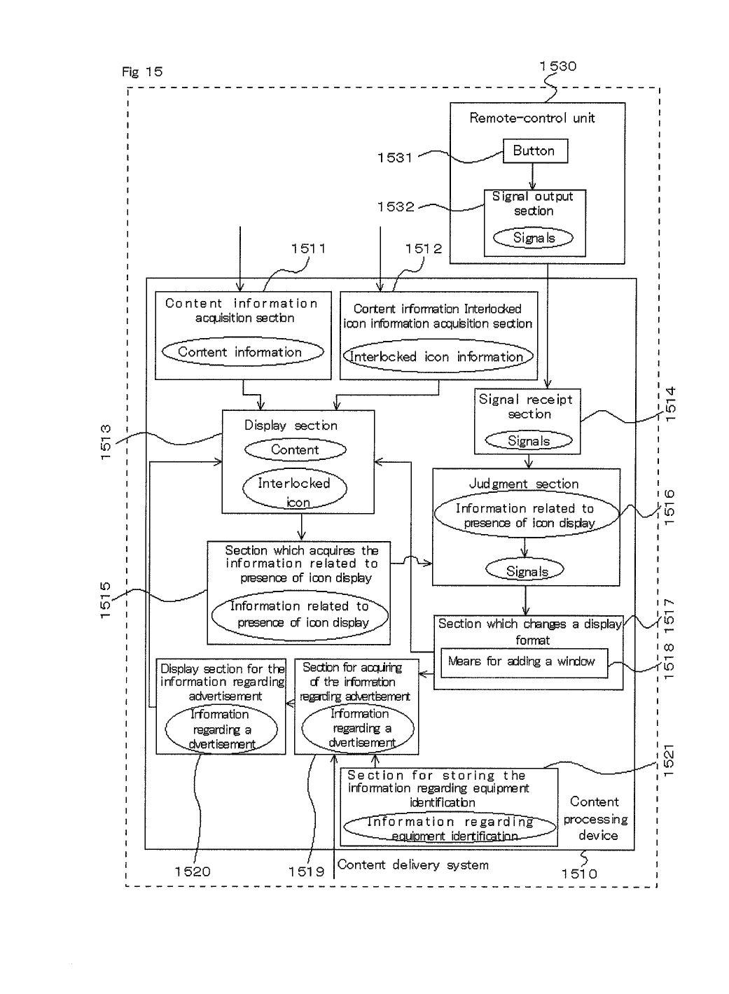

FIG. 15 is a functional block concerning the content delivery system of the embodiment. A configuration of the content delivery system of the embodiment is a configuration in which the section for storing information regarding equipment identification (1521) is added to the configuration of the content delivery system related to the fourth embodiment. The content delivery system retains the content processing device (1510) and the remote-control unit (1530). The content processing device (1510) retains a content information acquisition section (1511), an interlocked icon information acquisition section (1512), an display section (1513), a signal receipt section (1514), a section which acquires the information related to presence of icon display (1515), a judgment section (1516), a section which changes a display format (1517), a section for acquiring of the information regarding advertisement (1519), a display section for the information regarding advertisement (1520), and a section for storing the information regarding equipment identification (1521). Additionally, the section which changes the display format (1517) mentioned above retains a means for adding a window (1518). Moreover, the aforementioned remote-control unit (1530) retains the button (1531) and the signal output section (1532).

The section for storing the information regarding equipment identification (1521) retains the function which stores the information regarding equipment identification as the information physically identifying the content processing device. The term “the information regarding equipment identification” refers to equipment ID independently attached to each content processing device in order to distinguish the content processing device from other devices. The information regarding equipment identification may correspond to a serial number of content processing device or may separately correspond to items attached thereto based on certain regularity. More specifically, for instance, the section for storing the information regarding equipment identification is embodied by storage of the information regarding equipment identification in a predetermined storage area of HDD, RM, ROM, and the like. Additionally, it is more desirable if the information regarding equipment identification is stored in a tamper-resistant area.

Moreover, section for acquiring of the information regarding advertisement (1519) is characterized by acquisition of the aforementioned information regarding advertisement based on the information regarding equipment identification stored in the section for storing the information regarding equipment identification (1521). More specifically, for instance, inc as that the information regarding equipment identification corresponds to the information regarding equipment identification of “UVW001” stored in a predetermined storage area of HDD, RAM, ROM, and the like by the section for storing the information regarding equipment identification mentioned above, the section for acquiring of the information regarding advertisement mentioned above will read out the information regarding equipment identification of “UVW001” stored in a predetermined storage area. Also, connection with a party from which the information regarding advertisement is obtained will be executed via I/O of network card and the like. If the connection becomes successful, the read information regarding equipment identification will be sent to the party from which the information regarding advertisement is obtained. The party from which the information regarding advertisement is obtained stores the information regarding advertisement associated with the information regarding equipment identification, as the database, in a predetermined storage area. The information regarding advertisement associated with the information regarding equipment identification sent through searching for such database and the like, will be obtained. Furthermore, for example, when the information regarding equipment identification is associated with the information regarding users' preferences of the content processing device, it is possible to obtain the information regarding advertisement according to the users' preferences and it is expected that advertisement effect will be enhanced more increasingly. When the party from which the information regarding advertisement is obtained acquires the information regarding advertisement associated with the information regarding equipment identification, the information regarding advertisement will be sent to the content processing device. The section for acquiring of the information regarding advertisement will receive the sent information regarding advertisement via I/O of network card and the like, and will store the same in the predetermined storage area, such as HDD, RAM and the like. That is to say, at such time, the information regarding advertisement mentioned above has been obtained based on the information regarding equipment identification. Based on the aforementioned function, for instance, it is possible to receive the information regarding advertisement which differs from each content processing device.

### (Processing Flow of the Fifth Embodiment)

A processing flow of the content delivery system of the embodiment is the same as that of the content delivery system related to the fourth embodiment. However, the content delivery system is characterized by the fact that the information regarding equipment identification is stored, and the aforementioned information regarding advertisement will be acquired based on the information regarding equipment identification which has been stored in regards to the step for acquiring of the information regarding advertisement mentioned above.

### (Effect of the Fifth Embodiment)

In addition to the function of the content delivery system related to the fourth embodiment, the content delivery system of the embodiment retains a function that stores the information regarding equipment identification as information used to physically identify the content processing device. And the content delivery system is characterized by the fact that the section for acquiring of the information regarding advertisement obtains the information regarding advertisement mentioned above based on the stored information regarding equipment identification. Due to this, it is possible to obtain the information regarding advertisement which differs from each content processing device. For instance, due to obtaining and displaying the information regarding advertisement according to users' preferences of the content processing device, it is expected that advertisement effect will be enhanced more increasingly.

### Sixth Embodiment

### (Outline of the Sixth Embodiment)

In addition to a configuration of the content delivery system related to any one of the forth or fifth embodiments, the embodiment relates to the content delivery system which stores the information regarding advertisement and further retains the server supplying advertisements which outputs the information regarding advertisement in regards to the content processing device.

### (Sixth Embodiment: Structure)

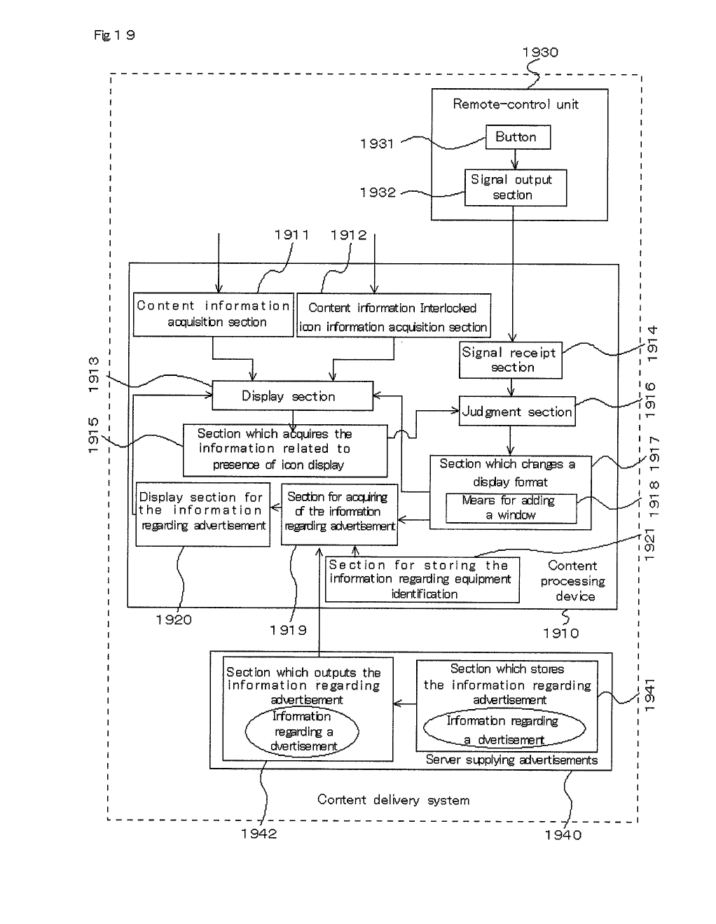

FIG. 19 is a functional block of the content delivery system of the embodiment. A configuration of the content delivery system of the embodiment is a configuration in which the configuration of a server supplying advertisements (1940) is added to the configuration of the content delivery system related to any one of the forth or fifth embodiments. In FIG. 19, a configuration in which the configuration regarding the server supplying advertisements (1940) mentioned above is added to the configuration of the fifth embodiment is exemplified. The content delivery system retains a content processing device (1910), a remote-control unit (1930), and a server supplying advertisements (1940). The content processing device (1910) mentioned above retains a content information acquisition section (1911), an interlocked icon information acquisition section (1912), a display section (1913), a signal receipt section (1914), a section which acquires the information related to presence of icon display (1915), a judgment section (1916), a section which changes a display format (1917), a section for acquiring of the information regarding advertisement (1919), a display section for the information regarding advertisement (1920), and a section for storing the information regarding equipment identification (1921). Additionally, the section which changes a display format (1917) mentioned above retains a means for adding a window (1918). Also, a remote-control unit (1930) mentioned above retains a button (1931) and the signal output section (1932). Moreover, a server supplying advertisements (1940) retains a section which stores the information regarding advertisement (1941), and a section which outputs the information regarding advertisement (1942).

The server supplying advertisements (1940) can be implemented via a server computer. The server supplying advertisements serves to supply the information regarding advertisement to the content processing device (1910) mentioned above. Also, the content processing device (1910) mentioned above and the server supplying advertisement mentioned above receive and send relevant information mutually. Public lines or may be use non public lines may be used for such receipt and transmission. A method for communication may depend on wired or wireless communication. In the case of wireless communication, for instance, invisible light of Bluetooth (registered trademark) or infrared rays and the like, or visible light may be acceptable.

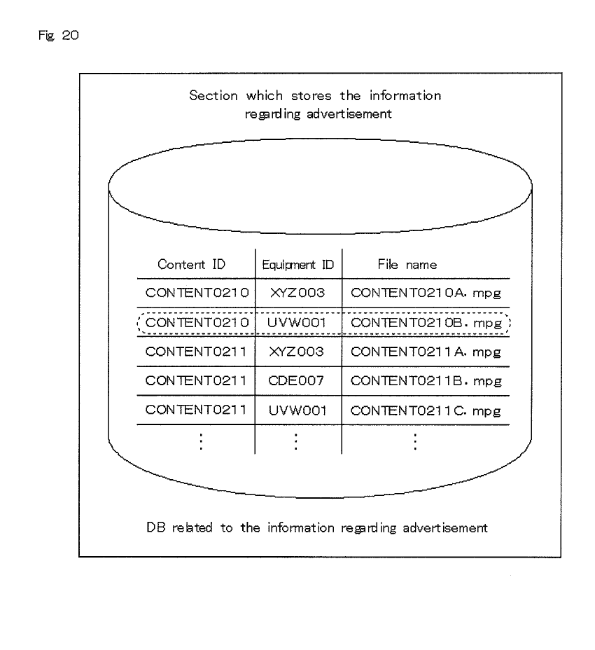

The section which stores the information regarding advertisement (1941) retains the function which stores the information regarding advertisement. A concrete example of the section which stores the information regarding advertisement is shown in FIG. 20. DB which stores the information regarding advertisement corresponds to the database which associates the information regarding equipment identification with the information regarding advertisement, and comprises the content ID, equipment ID, and file name. For example, the content ID refers to the information in order to identify a relevant content which has been viewed upon adding of a new window via the means for adding a window (1918) mentioned above. The equipment ID corresponds to the information regarding equipment identification. Also, the file name corresponds to a file name of a vide file for advertisement which corresponds to the information regarding advertisement. That is to say, the section which stores the information regarding advertisement is implemented by the database exemplified in FIG. 20 and a vide file for advertisement which has been separately stored in the predetermined storage area, such as HDD and RAM and the like. Moreover, in case that the information regarding equipment identification is associated with the information regarding advertisement, it is possible to output the information regarding advertisement which differs from each content processing device (details for a specific example concerning processing will be described below).

The section which outputs the information regarding advertisement (1942) retains the function which outputs the information regarding advertisement which has been stored in the section which stores the information regarding advertisement (1941) mentioned above to the section for acquiring of the information regarding advertisement (1919). For instance, in regards to the section which stores the information regarding advertisement (1941), hypothetically, implementation is made via using of the database as exemplified in FIG. 20. In case that the information of “content ID=‘CONTENT0210,” and equipment ID=‘UVW001’ as the content identification information and the information regarding equipment identification is outputted from the section for acquiring of the information regarding advertisement (1919) of the content processing device (1910) to the server supplying advertisements (1940), a file name of “CONTENTO210B.mpg” will be extracted from the DB related to the information regarding advertisement of the section which stores the information regarding advertisement (1941) mentioned above. Due to this, as the information regarding advertisement, a file of “CONTENTO210B.mpg” will be outputted from the section which outputs the information regarding advertisement to the section for acquiring of the information regarding advertisement (1919). Furthermore, more specifically, for instance, the section which outputs the information regarding advertisement contains the program which executes the aforementioned processing. And such program submits inquires via the content ID and equipment ID obtained from the content processing device via I/O of network card, and the like in regards to the database as in FIG. 20, which has been stored in the predetermined storage area, such as HDD, RAM, and the like, and store the obtained file name in a predetermined storage area of RAM, and the like. Moreover, the stored file name is read out, and a video file specified based on such file name is read out from a predetermined storage area. The video file which has been read out is outputted via I/O of network card. In addition, communication in regards to the section which outputs the information regarding advertisement may be wired or wireless. In the case of wireless communication, for instance, invisible light of Bluetooth (registered trademark) or infrared rays and the like, or visible light may be acceptable.

### (Processing Flow of the Sixth Embodiment)

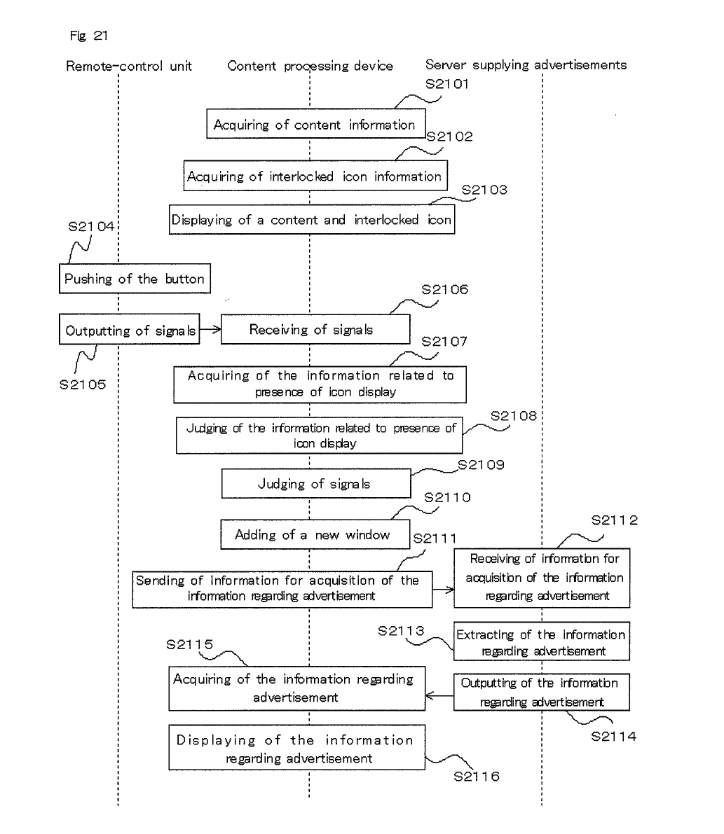

FIG. 21 is a sequence diagram showing a processing flow of the content delivery system of the embodiment.

Initially, the content processing device retains the content information. Such processing will be executed by the content information acquisition section (Step for acquiring of content information: S2101).

Subsequently, the interlocked icon information will be obtained. Such processing will be executed by the interlocked icon information acquisition section (Step for acquiring of interlocked icon information: S2102).

Then, the content and interlocked icon therewith are displayed in one area. Such processing will be executed by the display section (Display step: S2103).

Next, a button is pushed down on a remote control unit. Such processing will be executed by the button (Step for pushing of the button: S2104).

Subsequently, signals satisfying the predetermined conditions are outputted in conjunction with pushing down of a button which has been executed through the step for pushing of the button (S2104) mentioned above is outputted. Such processing will be executed by the signal output section (Step for outputting of signals: S2105).

Next, signals outputted through the step for outputting of signals (S2105) mentioned above are received by the content processing device. Such processing will be executed by the signal receipt section (Step for signal receipt: S2106).

Subsequently, the information related to presence of icon display which shows whether or not the interlocked icon has been displayed through the display step (S2103) is acquired. Such processing will be executed by the section which acquires the information related to presence of icon display (Step for acquiring of the information related to presence of icon display: S2107).

Next, it is judged whether or not the information related to presence of icon display obtained through the step for acquiring of the information related to presence of icon display (S2107) mentioned above corresponds to the information as to whether or not the interlocked icon has been displayed through the display step (S2103) mentioned above. In case that the judgment herein is made which such information corresponds to the effect that the interlocked icon has been displayed, the step for signal judgment (S2109) described as below will be chosen. In case that the judgment herein is made which such information corresponds to the effect that the interlocked icon has not been displayed, the processing will be ended. Such processing will be executed by the judgment section (Step for judging of presence of icon display: S2108).

Subsequently, in case that it is judged that the judgment result by the step for judging of presence of icon display (S2108) has corresponded to the information to the effect that the interlocked icon has been displayed, it will be judged whether or not signals received through the step for signal receipt (S2106) mentioned above satisfies predetermined conditions. In case that the judgment herein is made to the effect that predetermined conditions have been satisfied, a step for adding a window (S2110) described as below will be chosen. In case that the judgment herein is made to the effect that predetermined conditions have not been satisfied, the processing will be ended. Such processing will be executed by the judgment section (Step for signal judgment: S2109).

Next, in case that it is judged that the judgment result has satisfied the predetermined conditions through the step for signal judgment (S2109) mentioned above, a new window is added as a modification of a display formant through the display step (S2103) mentioned above. Such processing will be executed by the means for adding a window (Step for adding a window: S2110).

Next, in case that a new window has been added through the step for adding a window (S2110) mentioned above, communications are started in regards to the server supplying advertisements and the information in order to obtain the information regarding advertisement is sent. The information used to obtain the information regarding advertisement corresponds to the content ID, equipment ID, and the like as per the example of FIG. 20, for instance. Such processing will be executed by the section for acquiring of the information regarding advertisement (Step for sending the information regarding advertisement: S2111).

Next, the information sent via the step for sending the information regarding advertisement (S2111) mentioned above is received by the server supplying advertisements (Step for receiving the information regarding advertisement: S2112).

Next, based on the information received via the step for receiving the information regarding advertisement (S2112) mentioned above, the information regarding advertisement is extracted. Such processing will be mainly executed by the section which stores the information regarding advertisement (Step for extracting of the information regarding advertisement: S2113).

Next, the information regarding advertisement extracted via the step for extracting of the information regarding advertisement (S2113) mentioned above is outputted in regards to the section for acquiring of the information regarding advertisement of the content processing device. Such processing will be executed by the section which outputs the information regarding advertisement (Step for outputting of the information regarding advertisement: S2114).

Subsequently, the information regarding advertisement outputted via the step for outputting of the information regarding advertisement (S2114) mentioned above will be obtained. Such processing will be executed by section for acquiring of the information regarding advertisement (Step for acquiring of the information regarding advertisement: S2115).

Finally, the information regarding advertisement outputted via the step for acquiring of the information regarding advertisement (S2115) is displayed on a new window added through the step for adding a window (S2110) mentioned above. Such processing will be executed by display section for the information regarding advertisement (Step for displaying of the information regarding advertisement: S2116).

### (Effect of the Sixth Embodiment)

The content delivery system of the embodiment further retains the server supplying advertisements with the function which outputs the information regarding advertisement in regards to the content processing device. Due to this, the information regarding advertisement can be offered externally in regards to the content processing device.

### Seventh Embodiment

### (Outline of the Seventh Embodiment)

In addition to the function of the content delivery system related to any one of the first or sixth embodiments, the embodiment relates to the content delivery system with the function which receives broadcasting of the content mentioned above, and with the function of the aforementioned display section which displays the interlocked icon via the contents superimposed based on the received interlocked icon information.

### (Configuration of the Seventh Embodiment)

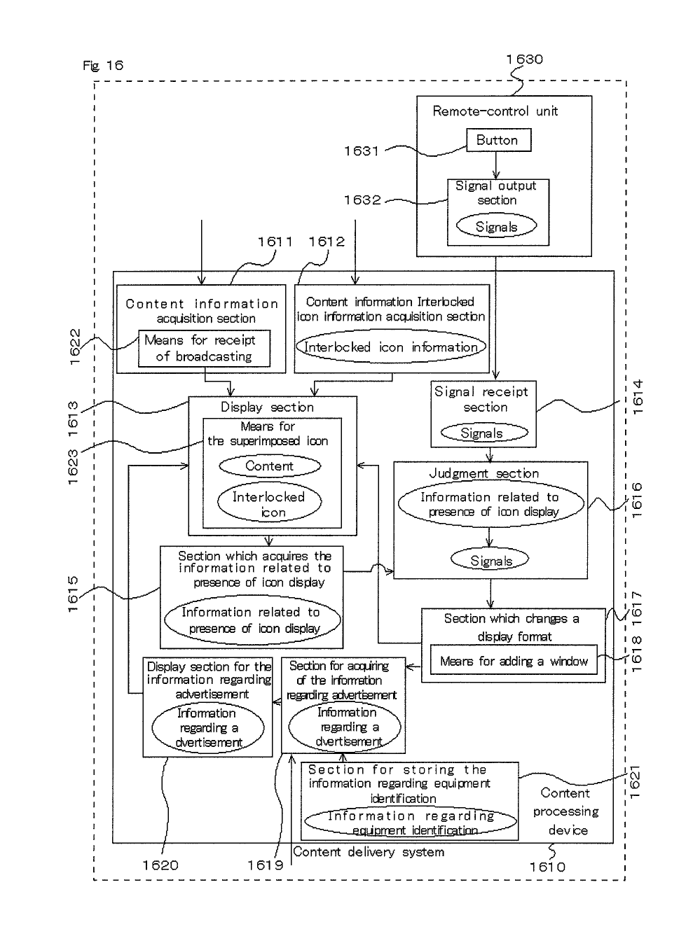

FIG. 16 is a functional block of the content delivery system of the embodiment. A configuration of the content delivery system of the embodiment corresponds to a configuration in which a means for receipt of broadcasting (1622) and a means for the superimposed icon (1623) are added to a configuration of the content delivery system related to any one of the first or sixth embodiments. In FIG. 16, a configuration in which a means for receipt of broadcasting (1622) and a means for the superimposed icon (1623) mentioned above are added to a configuration of the content delivery system related to the fifth embodiment is exemplified. The content delivery system retains a content processing device (1610) and a remote-control unit (1630). The content processing device (1610) retains a content information acquisition section (1611), an interlocked icon information acquisition section (1612), a display section (1613), a signal receipt section (1614), a section which acquires the information related to presence of icon display (1615), a judgment section (1616), a section which changes a display format (1617), a section for acquiring of the information regarding advertisement (1619), a display section for the information regarding advertisement (1620), and a section for storing the information regarding equipment identification (1621). Additionally, the content information acquisition section (1611) mentioned above retains a means for receipt of broadcasting (1622). The section which changes a display format (1617) mentioned above retains the means for adding a window (1618). Also, the aforementioned display section (1613) retains a means for the superimposed icon (1623). Moreover, the remote-control unit (1630) mentioned above retains a button (1631) and a signal output section (1632).

A means for receipt of broadcasting retains the function which receives the broadcasting of the content mentioned above. Broadcasting may depend on wired or wireless communication. Specially, for instance, cablecast, digital terrestrial broadcasting, digital satellite broadcasting, internet broadcasting, and like apply. In regards to the processing of the means for receipt of broadcasting, specifically, for instance, a relevant content is inputted as the image data via I/O of an image input terminal and the like, and the inputted image data is stored in the predetermined storage area, such as HDD and RAM and the like.

A means for the superimposed icon (1623) retains the function which displays the interlocked icon through the content superimposed based on the content information received via the means for receipt of broadcasting mentioned above and the interlocked icon information through the aforementioned interlocked icon information acquisition section (1612). In relation to “the content information received via the means for receipt of broadcasting mentioned above, and based on the interlocked icon information through the aforementioned interlocked icon information acquisition section,” for instance, in case that the interlocked icon information refers to the information to the effect that the interlocked icon is being displayed, a case where the image data of interlocked icon which has been separately stored within the content processing device is combined with the content image data can be assumed.

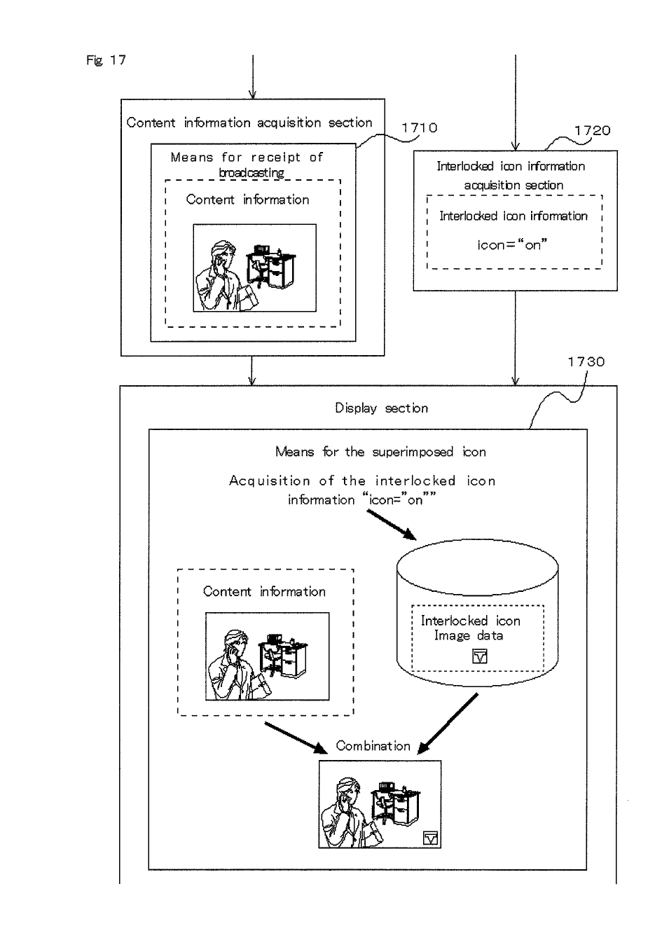

FIG. 17 shows a specific example of the means for the superimposed icon. First of all, hypothetically, the content information (image data applies as a matter of fact, however, in FIG. 17, the content embodied through the content information is illustrated on a conceptual basis) is acquired via the means for receipt of broadcasting (1710). And the interlocked icon information “icon=”on″″ has been obtained through the interlocked icon information acquisition section (1720). Such information “icon=”on″″ can be possible when such information is described in BML (Broadcast Markup Language), for instance. Next, in regards to the means for the superimposed icon (1730), due to the interlocked icon information “icon=”on″″ obtained through the means for the superimposed icon (1730), image data of interlocked icon which has been stored in a predetermined storage area is read out, and the content embodied through the content information received via means for receipt of broadcasting (1710) is combined with the interlocked icon in a superimposition manner. And the resultant item is displayed. Furthermore, specifically, for instance, the means for the superimposed icon may contain the program which executes the aforementioned processing. And such program orders CPU to read out the content information stored in a predetermined storage area via the means for receipt of broadcasting, and the interlocked information “icon=”on″″ stored in a predetermined storage area via the interlocked icon information acquisition section. CPU reads out the aforementioned information from a predetermined storage area. The read interlocked information “icon=”on″″ reads out the image data of the interlocked icon which has been stored in a predetermined storage area of HDD, and the like (Alternatively, the image data of the interlocked icon may be obtained by being included in the interlocked icon. Also, in lieu of the information “icon=”on,″″ whether or not the interlocked icon is displayed on the content may be judged depending on whether or not the image data of the interlocked icon can be obtained simultaneously with the content). CPU executes editing of the image data in order to combine the read content information with the image data of the interlocked icon. The edited image data is displayed to the graphic memory via a GPU. Thereafter, as needed, such image data will be converted into a display output signal based on analog conversion and the like, and such data will be outputted to a display.

### (Processing Flow of the Seventh Embodiment)

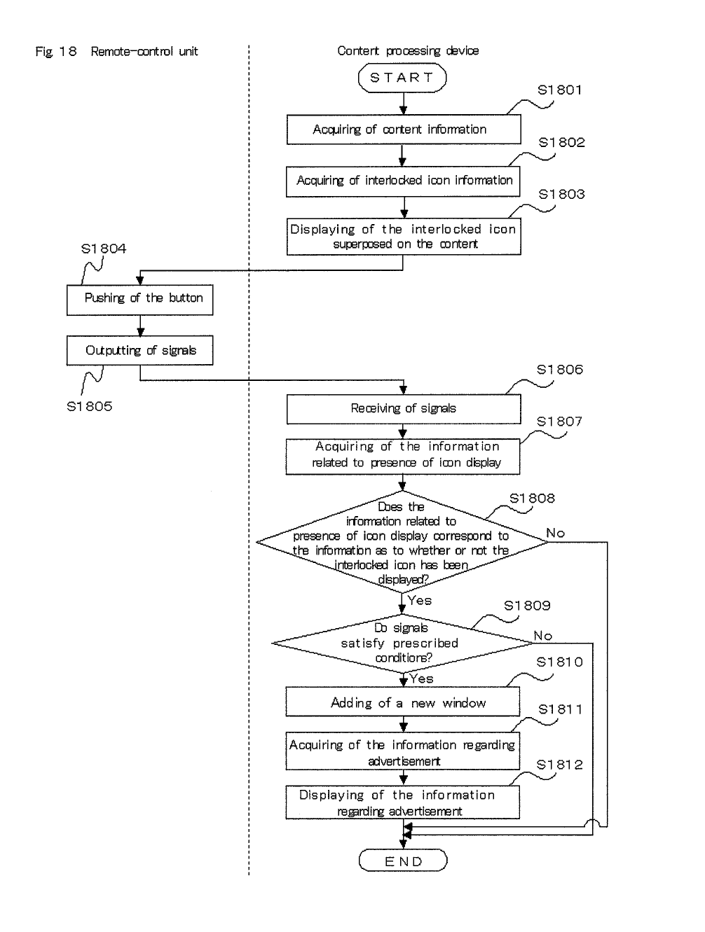

FIG. 18 is a flowchart which shows a processing flow of the content delivery of the embodiment.

Initially, the content processing device receives content broadcasting. Such processing will be executed by the means for receipt of broadcasting (Step for receipt of broadcasting: S1801).

Next, the interlocked icon information will be acquired. Such processing will be executed by the interlocked icon information acquisition section (Step for acquiring of interlocked icon information: S1802).

Subsequently, based on the content information received through the step for receipt of broadcasting (S1801) and the interlocked icon information obtained through the step for acquiring of interlocked icon information (S1802), the interlocked icon superimposed on the content is displayed. Such processing will be executed by the means for the superimposed icon (Display step concerning icon superimposition: S1803).

Then, a button is pushed via the remote-control unit. Such processing will be executed by the button (step for pushing of the button: S1804).

Subsequently, signals satisfying the predetermined conditions are outputted in conjunction with pushing down of a button which has been executed through the step for pushing of the button (S1804) mentioned above is outputted. Such processing will be executed by the signal output section (Step for outputting of signals: S1805).

Next, signals which have been outputted through the step for outputting of signals (S1805) mentioned above will be received by the content processing device. Such processing will be executed by the signal receipt section (Step for signal receipt: S1806).

Next, the information related to presence of icon display which shows whether or not the interlocked icon has been displayed through the display step concerning icon superimposition (S1803) will be acquired. Such processing will be executed by the section which acquires the information related to presence of icon display (Step for acquiring of the information related to presence of icon display: S1807).

Next, in relation to the information related to presence of icon display (S1807) obtained through the aforementioned step for acquiring of the information related to presence of icon display (S1807), it is judged whether or not the interlocked icon has be en displayed via the display step concerning icon superimposition (S1803). n case that the judgment herein is made which such information corresponds to the effect that the interlocked icon has been displayed, the step for signal judgment (S1809) described as below will be chosen. In case that the judgment herein is made which such information corresponds to the effect that the interlocked icon has not been displayed, the processing will be ended. Such processing will be executed by the judgment section (Step for judging of presence of icon display: S1808).

Next, in case that it is judged that the judgment result by the step for judging of presence of icon display (S1808) mentioned above corresponds to the information to the effect that the interlocked icon has been displayed, it will be judged whether or not signals received through the step for signal receipt (S1806) mentioned above satisfies predetermined conditions. In case that the judgment herein is made which the signal received satisfies predetermined conditions, the step for adding a window (S1810) described as below will be chosen. In here, in case that it is judged that the signal received does not predetermined conditions, the processing will be ended. Such processing will be executed by the step for signal judgment (Step for signal judgment: S1809).

Next, in case that the judgment result through the aforementioned step for signal judgment (S1809) is made which predetermined conditions have been net, as a modification of display format through the display step concerning icon superimposition (S1803) mentioned above, a new window is added. Such processing will be executed by the means for adding a window (Step for adding a window S1810).

Subsequently, when a new window has been added via the step for adding a window (S1810) mentioned above, the information regarding advertisement will be acquired via starting of communications. Such processing will be executed by the section for acquiring of the information regarding advertisement (Step for acquiring of the information regarding advertisement: S1811).

Finally, the information regarding advertisement obtained via the step for acquiring of the information regarding advertisement (S1811) will be displayed on a new window added through the step for adding a window (S1810) mentioned above. Such processing will be executed by the display section for the information regarding advertisement (Step for displaying of the information regarding advertisement: S1812).

### (Effect of the Seventh Embodiment)

In addition to the function of the content delivery system related to any one of the first through fifth embodiments, the content delivery system retains the function which receives the aforementioned content broadcasting, superimposes the received content information and the obtained interlocked information on the content, and resultant interlocked icon is displayed. Due to this, for instance, even in case that the content information and interlocked icon information are received at different time instances, it is possible to superimpose the content and interlocked icon and to display the resultant item.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A content delivery system with a content processing device comprising:
a content information acquisition section, which acquires content information;
an interlocked icon information acquisition section, which acquires interlock ked icon information as interlocked icon information that is interlocked with the content displayed via the content information;
a display section, which displays content and an icon interlocked with the aforementioned content in one area;
signals receipt section, which receives signals;
a section for acquiring information related to the presence of an icon display, which obtains information related to the presence of an icon display showing whether or not the interlocked icon has been displayed in the display section mentioned above;
a judgment section, which judges whether the signal received by the signal receipt section satisfies predetermined conditions or not when the information related to presence of icon display obtained by the section that acquires the information related to presence of icon display corresponds to the information to the effect that the interlocked icon has been displayed in the display section; and
a section that changes display format, which changes display format of the display section when it is judged by the judgment section that predetermined conditions have been satisfied.

2. The content delivery system with a remote-control unit of the content processing device according to claim 1, further comprising:
a button; and
signals output section outputting signals, which satisfies predetermined conditions by being interlocked with the pushing down of such button.

3. The content delivery system according to claim 1, wherein a section that changes a display format retains a function for adding a new window to the display section as modification of the display format.

4. The content delivery system according to claim 3, comprising:
a section for acquiring the information regarding advertisement, which starts communications and obtains information regarding advertisement when a new window has been added via the means for adding a window; and
a display section for information regarding advertisement, which displays the information regarding advertisement obtained via the section for acquiring of the information regarding advertisement in a new window that has been added via the means for adding a window.

5. The content delivery system according to claim 4, comprising:
a section for storing information regarding equipment identification, which stores information regarding equipment identification as information used to physically identify the content processing device;
wherein the section for acquiring communication for information regarding advertisement obtains the information regarding advertisement based on the information regarding equipment identification stored in the section for storing the information regarding equipment identification.

6. The content delivery system according to claim 4, further comprising a server supplying advertisements with a section that stores information regarding advertisement storing the information regarding advertisement and with a section that outputs the information regarding advertisement outputting information regarding advertisement that has been stored in the section that stores information regarding advertisement to the section for acquiring communications for information regarding advertisement.

7. The content delivery system according to claim 1, wherein the content information acquisition section retains a means for receipt of broadcasting regarding the content that displays the interlocked icon through the content superimposed based on the content information received via the means for receipt of broadcasting and the interlocked icon information through the interlocked icon information acquisition section.

8. The content delivery system according to claim 1, wherein the content corresponds to a TV program.

9. A content delivery method comprising the steps of:
acquiring of content information;
acquiring interlocked icon information, which involves the acquisition of interlocked icon information as interlocked icon information that is interlocked with the content displayed via the content information;
displaying the content and an icon interlocked with the content in one area;
receiving signals;
acquiring of the information related to presence of icon display, which obtains the information related to the presence of an icon display showing whether or not the interlocked icon has been displayed in the display section;
judging whether the signal received by the step for signal receipt satisfies predetermined conditions or not, when the information related to presence of icon display obtained by the step for acquiring of the information related to presence of icon display corresponds to the information to the effect that the interlocked icon has been displayed in the display step; and
changing display format used to change the display format of the display step in case that the judgment result of the judgment step satisfies predetermined conditions.

10. The content delivery method according to claim 9, further comprising a step of outputting signals, which satisfies predetermined conditions by being interlocked with the pushing down of such button.

11. The content delivery method according to claim 9, wherein when the step for changing display format includes a step for adding a window that adds a new window as a modification of display format when display format is changed in connection with the display step.

12. The content delivery method according to claim 11, comprising the steps of:
acquiring of communications for information regarding advertisement, which retains a function that starts communications and obtains information regarding advertisement when a new window has been added via the step for adding a window; and
displaying information regarding advertisement, which displays the information regarding advertisement obtained via the step for acquiring communications for the information regarding advertisement in a new window that has been added via the step for adding a window.

13. The content delivery method according to claim 12, comprising the step of:
storing information regarding equipment identification, stores information regarding equipment identification as information used to physically identify the content processing device;
wherein the step for acquiring communications for information regarding advertisement obtains the information regarding advertisement based on the information regarding equipment identification stored in the step for storing information regarding equipment identification.

14. The content delivery method according to claim 9, wherein the step for acquiring content information includes a step for receipt of broadcasting, in which there is receipt of content broadcasting and a display step includes a superimposed icon step which displays the interlocked icon via the content superimposed based on the interlocked icon information obtained through step for acquiring of interlocked icon information and the content information received through the step for receipt of broadcasting.

15. The content delivery system according to claim 2, wherein a section that changes a display format retains a function for adding a new window to the display section as modification of the display format.

16. The content delivery system according to claim 5, further comprising a server supplying advertisements with a section that stores information regarding advertisement storing the information regarding advertisement and with a section that outputs the information regarding advertisement outputting information regarding advertisement that has been stored in the section that stores information regarding advertisement to the section for acquiring communications for information regarding advertisement.

17. The content delivery system according to claim 2, wherein the content information acquisition section retains a means for receipt of broadcasting regarding the content that displays the interlocked icon through the content superimposed based on the content information received via the means for receipt of broadcasting and the interlocked icon information through the interlocked icon information acquisition section.

18. The content delivery system according to claim 3, wherein the content information acquisition section retains a means for receipt of broadcasting regarding the content that displays the interlocked icon through the content superimposed based on the content information received via the means for receipt of broadcasting and the interlocked icon information through the interlocked icon information acquisition section.

19. The content delivery system according to claim 4, wherein the content information acquisition section retains a means for receipt of broadcasting regarding the content that displays the interlocked icon through the content superimposed based on the content information received via the means for receipt of broadcasting and the interlocked icon information through the interlocked icon information acquisition section.

20. The content delivery system according to claim 5, wherein the content information acquisition section retains a means for receipt of broadcasting regarding the content that displays the interlocked icon through the content superimposed based on the content information received via the means for receipt of broadcasting and the interlocked icon information through the interlocked icon information acquisition section.
